(19) United States
(12) Patent Application Publication
(10) Pub. No.: US 2024/0357378 A1
(43) Pub. Date: Oct. 24, 2024

(54) INTER-CELL BEAM MANAGEMENT METHOD AND APPARATUS

(71) Applicant: FUJITSU LIMITED, Kawasaki-shi Kanagawa (JP)

(72) Inventors: Meiyi JIA, Beijing (CN); Guorong LI, Beijing (CN)

(73) Assignee: FUJITSU LIMITED, Kawasaki-shi Kanagawa (JP)

(21) Appl. No.: 18/762,738

(22) Filed: Jul. 3, 2024

Related U.S. Application Data
(63) Continuation of application No. PCT/CN2022/070834, filed on Jan. 7, 2022.

(51) Int. Cl. H04W 16/28; H04B 7/06; H04W 56/00; H04W 76/20

(52) U.S. Cl. CPC H04W 16/28; H04B 7/0626; H04B 7/06968; H04W 56/0015; H04W 76/20

(57) ABSTRACT

An inter-cell beam management apparatus, applicable to a network device, includes: a transmitter configured to: transmit configuration information of a beam of a non-serving cell to a terminal equipment; and transmit a reference signal of a TCI state with which a serving cell is associated to the terminal equipment.

### CROSS-REFERENCE TO RELATED APPLICATION

This application is a continuation application of International Application PCT/CN2022/070834 filed on Jan. 7, 2022, and designated the U.S., the entire contents of which are incorporated herein by reference.

### TECHNICAL FIELD

This disclosure relates to the field of communication technologies.

### BACKGROUND

Rel-15 NR includes some MIMO (multiple input multiple output) features to promote use of a large number of antenna elements at frequency bands below and above 6 GHz at a base station side.

Rel-16 NR enhances Rel-15 NR by introducing enhanced Type II codebooks based on discrete Fourier transform (DFT) compression, supporting multiple transmission reception points (TRP) transmission, especially for an enhanced mobile broadband (eMBB) and a physical downlink shared channel (PDSCH), enhancement of multi-beam operations, including reduction of measurement reconfiguration overhead related to latency and/or multiple quasi-colocation (QCL), secondary cell (SCell) beam failure recovery (BFR), a, L1-SINR, a peak-to-average power ratio (PAPR) reference signal, and ensuring characteristics of uplink full power transmission.

NR is currently in a process of commercialization, and from actual deployment scenarios, various aspects that need to be further enhanced can be identified, such as inter-cell beam management (ICBM), including:

Rel-16 has managed to reduce overhead and/or latency, and high-speed vehicle scenarios on FR2 (such as terminal equipments traveling at high speeds on highways) require more active reduction of latency and overhead, not only for intra-cell but also for inter-cell L1 and L2 layer mobility, which further includes reducing occurrence of beam failure events;

Rel-16 studied enhancement of ensuring panel-specific uplink (UL) beam selection, but did not have enough time to complete the work. This provides some possibilities for increasing uplink coverage, including alleviating uplink coverage losses caused by satisfying a maximum permissible exposure (MPE) rule;
channels other than a PDSCH can benefit from multi-TRP transmission (as well as multi-panel reception), which also includes inter-cell multi-TRP operations. This includes some new multi-TRP use cases, such as scenarios of uplink dense deployment within a macro cell and/or deployment of heterogeneous network types;
due to the use of multi-scenario SRSs, at least for capacity and coverage, it is possible and necessary to further enhance the channel sounding reference signals (SRSs);
although Rel-16 supports enhanced Type II channel state information (CSI), some rooms for further enhancement may be sensed. This includes utilization of CSI and some heterogeneities of channel statistics designed for multi-TRP/panel for NC-JT use cases, such as angles and latency, with a major goal of deployment of FR1 frequency division duplex (FDD).

Therefore, Rel-17 NR defines further enhancement of NR MIMO, including enhancement of multi-beam operations, with a major goal of FR2, which is also applicable to FR1, including: 1) for intra-cell and inter-cell scenarios, determining and defining characteristics that promote more efficient (lower latency and overhead) downlink/uplink (DL/UL) beam management, so as to support higher terminal equipment speeds and/or more configured transmission configuration indication (TCI) states, which are as follows:
common beams for downlink and uplink, data and control transmission/reception, especially for intra-band carrier aggregation (intra-band CA);
a unified TCI architecture for downlink and uplink beam indications;
enhancement of a signaling mechanism of the above characteristics improves latency and efficiency by more use of dynamical control signaling (relative to RRC);
for inter-cell beam management, a terminal equipment only transmits to or receives from a single cell (i.e. a serving cell remains unchanged when beam selection is completed). This includes L1-only measurement/report (i.e. no L3 impact) and a cell-associated beam indication of any physical cell identity (PCI), wherein the beam indication is based on a unified TCI architecture of Rel-17; reuse of beam measurement/reporting mechanism of inter-cell mTRPs; and intra-distribution unit (intra-DU) and intra-frequency situations are only taken into account.
2) taking mitigating the uplink coverage losses caused by the MPE, determining and defining characteristics that promote uplink beam selection for a terminal equipment equipped with multiple panels, and using a unified TCI architecture selected by the uplink fast panel based on the uplink beam indication.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

A terminal equipment in a connected state performs radio link monitoring (RLM) in an active BWP (bandwidth part) based on a reference signal (such as a synchronization signal block (SSB) and/or a channel state information reference signal CSI-RS) and a signal quality threshold configured by a network, wherein the radio link monitoring based on the SSB is based on an SSB associated with an initial downlink BWP, and is only configured for the initial downlink BWP and a downlink BWP (DL BWP) including the SSB associated with the initial downlink BWP; and for other downlink BWPs, radio link monitoring based on CSI-RS is only performed.

The terminal equipment monitors quality of a downlink radio link of a primary cell (PCell) and indicates an out-of-synchronization or synchronization state to a higher layer; and if the terminal equipment is configured with a secondary cell group (SCG), the terminal equipment monitors quality of a downlink radio link of a primary secondary cell (PSCell) of the secondary cell group.

As to each downlink BWP of a special cell (including a primary cell and a secondary cell), for radio link monitoring, FailureDetectionResources configure a group of resource indices for the terminal equipment via a corresponding group of RadioLinkMonitoringRS.

If a terminal equipment is configured with multiple downlink BWPs of a serving cell, the terminal equipment performs radio link monitoring by using a reference signal to which a resource index provided by RadioLinkMonitoringRS of the active downlink BWP corresponds; or, if RadioLinkMonitoringRS of the active downlink BWP is not provided, a reference signal provided by an active TCI state associated with PDCCH reception in a control resource set (CORESET) on the active downlink BWP is used.

If the terminal equipment is not provided with an RLM RS (RadioLinkMonitoringRS) and is provided with TCI states associated with PDCCH reception including one or more CSI-RSs, for radio link monitoring, if the active TCI state associated with the PDCCH reception only includes one reference signal (RS), the terminal equipment uses the reference signal provided by the active TCI associated with the PDCCH reception;
if the active TCI state associated with the PDCCH reception includes two reference signals, the terminal equipment expects that a QCL type (qcl-Type) configured by one reference signal is set to be “typeD” and uses the reference signal with a QCL type set to be “typeD” for radio link monitoring, and the terminal equipment does not expect that both the reference signals are configured as having QCL types that are set to be “typeD”. For radio link monitoring, the terminal equipment is not required to use an aperiodic or semi-persistent reference signal.

It was found by the inventors that based on existing techniques, if a terminal equipment is not provided with a radio link monitoring reference signal (RLM RS) and is provided with TCI states associated with PDCCH reception including one or more CSI-RSs, for radio link monitoring, the terminal equipment uses a reference signal provided by an active TCI state associated with PDCCH reception.

For inter-cell beam management, following problems exist: when a TCI state associated with reception of a downlink dedicated channel (such as a physical downlink control channel (PDCCH) and/or a physical downlink shared channel (PDSCH)) of a cell other than a serving cell is activated for a terminal equipment and the terminal equipment is not provided with a reference signal for radio link monitoring, according to existing techniques, the terminal equipment uses a reference signal provided for the active TCI state of the cell other than the serving cell for radio link monitoring, which is unable to be used for radio link failure (RLF) detection of the serving cell, and may delay recovery of radio resource control (RRC) connection, thereby causing service interruption.

In addition, based on the existing techniques, if a terminal equipment is not provided with a reference signal for radio link monitoring and is provided with TCI states associated with reception including one or more DL dedicated channels (DCHs), each TCI state includes one or two reference signals, and each reference signal is associated with a serving cell. For inter-cell beam management, the TCI state needs to be associated with a downlink dedicated channel of a cell other than a serving cell. The existing mechanism is unable to support such configuration, and is unable to achieve inter-cell beam management.

In order to solve one or more of the above problems, embodiments of this disclosure provide an inter-cell beam management method and apparatus.

According to a first aspect of the embodiments of this disclosure, there is provided an inter-cell beam management apparatus, applicable to a terminal equipment, the apparatus including: a first receiving unit configured to receive configuration of a beam of a non-serving cell from a network device; and a first detecting unit configured to perform radio link failure detection by using a reference signal configured by the network device for radio link failure detection; or, a second detecting unit configured to perform radio link failure detection by using a reference signal of a TCI state with which a serving cell is associated.

According to a second aspect of the embodiments of this disclosure, there is provided an inter-cell beam management apparatus, applicable to a network device, the apparatus including: a first transmitting unit configured to transmit configuration of a beam of a non-serving cell to a terminal equipment; and a second transmitting unit configured to transmit a reference signal for radio link failure detection to the terminal equipment; and/or, a third transmitting unit configured to transmit a reference signal of a TCI state with which a serving cell is associated to the terminal equipment.

According to a third aspect of the embodiments of this disclosure, there is provided an inter-cell beam management apparatus, applicable to a terminal equipment, the apparatus including: a fourth receiving unit configured to receive TCI state information of a non-serving cell from a network device.

According to a fourth aspect of the embodiments of this disclosure, there is provided an inter-cell beam management apparatus, applicable to a network device, the apparatus including: a sixth transmitting unit configured to transmit TCI state information of a non-serving cell to a terminal equipment.

According to a fifth aspect of the embodiments of this disclosure, there is provided a terminal equipment, including the apparatus as described in the first aspect of the embodiments of this disclosure.

According to a sixth aspect of the embodiments of this disclosure, there is provided a network device, including the apparatus as described in the second aspect of the embodiments of this disclosure.

According to a seventh aspect of the embodiments of this disclosure, there is provided a terminal equipment, including the apparatus as described in the third aspect of the embodiments of this disclosure.

According to an eighth aspect of the embodiments of this disclosure, there is provided a network device, including the apparatus as described in the fourth aspect of the embodiments of this disclosure.

According to a ninth aspect of the embodiments of this disclosure, there is provided a communication system, including the terminal equipment as described in the fifth aspect of the embodiments of this disclosure and/or the network device as described in the sixth aspect of the embodiments of this disclosure.

According to a tenth aspect of the embodiments of this disclosure, there is provided a communication system, including the terminal equipment as described in the seventh aspect of the embodiments of this disclosure and/or the network device as described in the eighth aspect of the embodiments of this disclosure.

According to an eleventh aspect of the embodiments of this disclosure, there is provided an inter-cell beam management method, applicable to a terminal equipment, the method including: receiving configuration of a beam of a non-serving cell from a network device; and performing radio link failure detection by using a reference signal configured by the network device for radio link failure detection; or, performing radio link failure detection by using a reference signal of a TCI state with which a serving cell is associated.

According to a twelfth aspect of the embodiments of this disclosure, there is provided an inter-cell beam management method, applicable to a network device, the method including: transmitting configuration of a beam of a non-serving cell to a terminal equipment; and transmitting a reference signal for radio link failure detection to the terminal equipment; and/or, transmitting a reference signal of a TCI state with which a serving cell is associated to the terminal equipment.

According to a thirteenth aspect of the embodiments of this disclosure, there is provided an inter-cell beam management method, applicable to a terminal equipment, the method including: receiving TCI state information of a non-serving cell from a network device.

According to a fourteenth aspect of the embodiments of this disclosure, there is provided an inter-cell beam management method, applicable to a network device, the method including: transmitting TCI state information of a non-serving cell to a terminal equipment.

According to a fifteenth aspect of the embodiments of this disclosure, there is provided a computer readable program, which, when executed in an inter-cell beam management apparatus or a terminal equipment, will cause the inter-cell beam management apparatus or the terminal equipment to carry out the inter-cell beam management method described in the eleventh or thirteenth aspect of the embodiments of this disclosure.

According to a sixteenth aspect of the embodiments of this disclosure, there is provided a computer readable medium, including a computer readable program code, which will cause an inter-cell beam management apparatus or a terminal equipment to carry out the inter-cell beam management method described in the eleventh or thirteenth aspect of the embodiments of this disclosure.

According to a seventeenth aspect of the embodiments of this disclosure, there is provided a computer readable program, which, when executed in an inter-cell beam management apparatus or a network device, will cause the inter-cell beam management apparatus or the network device to carry out the inter-cell beam management method described in the twelfth or fourteenth aspect of the embodiments of this disclosure.

According to an eighteenth aspect of the embodiments of this disclosure, there is provided a computer readable medium, including a computer readable program code, which will cause an inter-cell beam management apparatus or a network device to carry out the inter-cell beam management method described in the twelfth or fourteenth aspect of the embodiments of this disclosure.

An advantage of the embodiments of this disclosure exists in that the terminal equipment uses the reference signal configured by the network device for radio link failure detection to perform radio link failure detection upon receiving configuration of a beam of a non-serving cell from the network device, or uses the reference signal of the TCI state associated with the serving cell for radio link failure detection. Hence, in inter-cell beam management, radio link failure detection of the serving cell may be performed, so as to avoid delays in RRC connection recovery and service interruptions, thereby ensuring system performances.

In addition, the terminal equipment receives the TCI state information of the non-serving cell from the network device, hence, inter-cell beam management may be achieved when a terminal equipment is not provided with a reference signal for radio link monitoring and is provided with a TCI state associated with reception including one or more downlink dedicated channels.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of this disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of the embodiments of this disclosure;

FIG. 2 is a schematic diagram of a scenario of inter-cell beam management of the embodiments of this disclosure;

FIG. 3 is a schematic diagram of a scenario of inter-cell multi-TRP of the embodiments of this disclosure;

FIG. 4 is a schematic diagram of the inter-cell beam management method of embodiment 1 of this disclosure;

FIG. 5 is a schematic diagram of a method for achieving step 401 of embodiment 1 of this disclosure;

FIG. 6 is a schematic diagram of the inter-cell beam management method of embodiment 2 of this disclosure;

FIG. 7 is a schematic diagram of a method for achieving step 601 of embodiment 2 of this disclosure;

FIG. 8 is a schematic diagram of the inter-cell beam management method of embodiment 3 of this disclosure;

FIG. 9 is another schematic diagram of the inter-cell beam management method of embodiment 3 of this disclosure;

FIG. 10 is a schematic diagram of the inter-cell beam management method of embodiment 4 of this disclosure;

FIG. 11 is a schematic diagram of the inter-cell beam management method of embodiment 5 of this disclosure;

FIG. 12 is a schematic diagram of the inter-cell beam management apparatus of embodiment 6 of this disclosure;

FIG. 13 is a schematic diagram of the first receiving unit of embodiment 6 of this disclosure;

FIG. 14 is a schematic diagram of the inter-cell beam management apparatus of embodiment 7 of this disclosure;

FIG. 15 is a schematic diagram of the first transmitting unit of embodiment 7 of this disclosure;

FIG. 16 is a schematic diagram of the inter-cell beam management apparatus of embodiment 8 of this disclosure;

FIG. 17 is a schematic diagram of the inter-cell beam management apparatus of embodiment 9 of this disclosure;

FIG. 18 is a block diagram of a systematic structure of the terminal equipment of embodiment 10 of this disclosure;

FIG. 19 is a block diagram of a systematic structure of the network device of embodiment 11 of this disclosure;

FIG. 20 is a block diagram of a systematic structure of the terminal equipment of embodiment 12 of this disclosure; and

FIG. 21 is a block diagram of a systematic structure of the network device of embodiment 13 of this disclosure.

### DETAILED DESCRIPTION

These and further aspects and features of this disclosure will be apparent with reference to the following description and attached drawings. In the description and drawings, particular embodiments of this disclosure have been disclosed in detail as being indicative of some of the ways in which the principles of this disclosure may be employed, but it is understood that this disclosure is not limited correspondingly in scope. Rather, this disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. For example, a 5G base station gNB may include a gNB CU and one or more gNB DUs, wherein the CU/DU is/are a logical node(s) of a gNB having some functions of a gNB. And a term “cell” may refer to a base station and/or its coverage area, depending on a context of the term. One gNB-DU supports one or more cells, and one cell is supported by only one gNB-DU.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc., such as a terminal equipment in an IAB architecture served by an IAB-node or an IAB-donor.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, all of “when . . . ”, “in a case where . . . ”, “for a case where . . . ” and “if . . . ” denote being based on one or some conditions or states, and furthermore, all of these expressions are interchangeable.

Scenarios of the embodiments of this disclosure shall be described below by way of examples; however, this disclosure is not limited thereto.

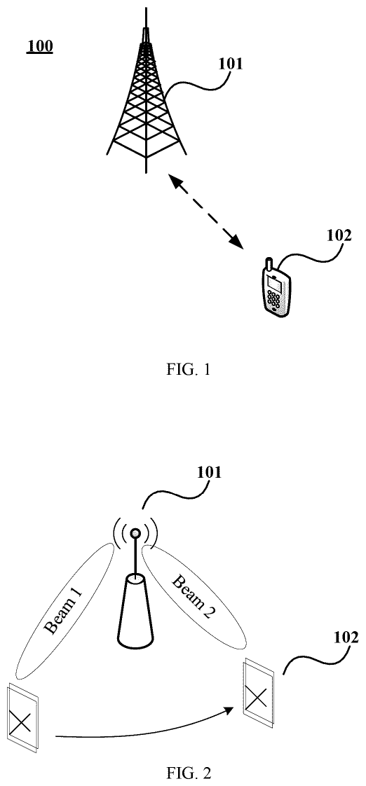

FIG. 1 is a schematic diagram of a communication system of an embodiment of this disclosure, in which a case where a terminal equipment and a network device are taken as examples is schematically shown. As shown in FIG. 1, a communication system 100 may include a network device 101 and a terminal equipment 102. For the sake of simplicity, an example having only one terminal equipment is schematically given in FIG. 1. The network device 101, for example, is a network device gNB of NR.

In the embodiments of this disclosure, existing traffics or traffics that may be implemented in the future may be performed between the network device 101 and the terminal equipment 102. For example, such traffics may include but not limited to enhanced mobile broadband (eMBB), massive machine type communication (MTC), and ultra-reliable and low-latency communication (URLLC), etc.

For example, the terminal equipment 102 performs communication by using a beam on a cell other than a serving cell (a non-serving cell). Scenarios of the embodiments of this disclosure shall be described below in detail.

For example, for a scenario of inter-cell beam management, the network device 101 provides services to the terminal equipment 102 via a serving cell and a cell other than the serving cell, i.e. a non-serving cell, the serving cell and the non-serving cell belonging to the same distribution unit (DU) of the network device 101.

FIG. 2 is a schematic diagram of the scenario of inter-cell beam management of an embodiment of this disclosure. As shown in FIG. 2, the network device 101 configures beam 1 on the serving cell (cell 1) and beam 2 on the non-serving cell (cell 2) for the terminal equipment 102. Due to movement of the terminal equipment 102, the network device 101 communicates with the terminal equipment 102 by sequentially using beam 1 on the serving cell and beam 2 on the non-serving cell.

For another example, for a scenario of inter-cell multi-TRP (mTRP), the network device provides services to the terminal equipment 102 via TRP-1 and TRP-2, the two TRPs belonging to different cells.

In the embodiments of this disclosure, a TRP is a part of a network device that receives signals from the terminal equipment and/or transmits signals to the terminal equipment. In multi-TRP (mTRP) operations, a serving cell may schedule the terminal equipment from two TRPs, providing better PDSCH coverage, reliability, and/or data rates. The two TRPs may belong to the same cell or different cells. For the multi-TRP, there are two different operating modes, namely single-DCI (downlink control information) and multi-DCI. For these two modes, within configuration provided by an RRC layer, control of uplink and downlink operations is performed by a physical layer and an MAC layer. In the single-DCI mode, the terminal equipment is scheduled by two TRPs via identical DCI, and in the multi-DCI mode, the terminal equipment is scheduled by separate DCI of each TRP.

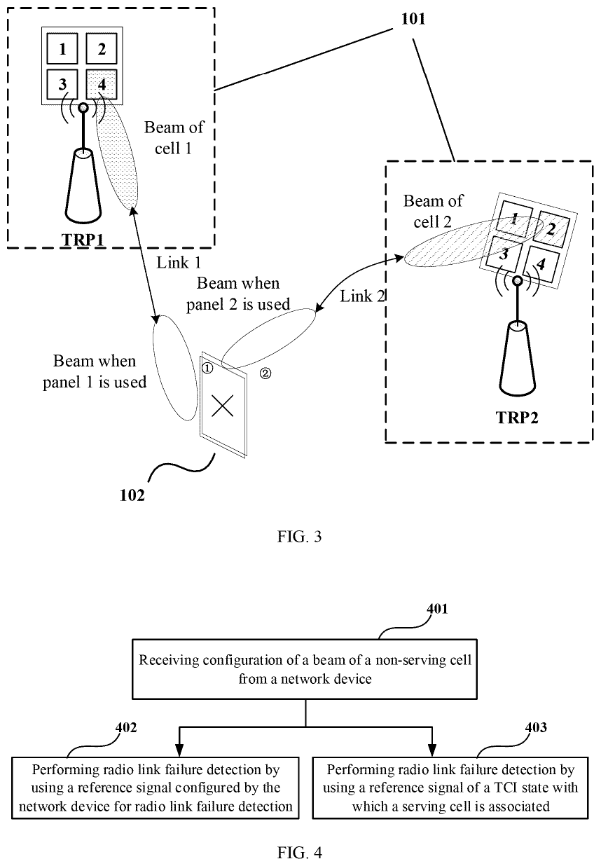

FIG. 3 is a schematic diagram of a scenario of inter-cell multi-TRP of the embodiments of this disclosure. As shown in FIG. 3, the network device 101 deploys two TRPs, TRP1 and TRP2. The network device 101 operates with the terminal equipment 102 via TRP1 and TRP2. TRP1 and TRP2 belong to different cells; for example, TRP1 belongs to cell 1, and TRP2 belongs to cell 2. TRP1 communicates with the terminal equipment 102 using panel 1 via link 1 by using a beam of cell 1, and TRP2 communicates with the terminal equipment 102 using panel 2 via link 2 by using a beam of cell 2.

In the scenarios shown in FIGS. 2 and 3, when a TCI state associated with downlink dedicated channel reception of the non-serving cell (cell 2) is activated for the terminal equipment 102, if the terminal equipment 102 is not provided with a reference signal for radio link monitoring, according to existing techniques, the terminal equipment 102 uses a reference signal provided for the active TCI state of the non-serving cell for radio link monitoring. This is unable to be used for radio link failure detection of the serving cell (cell 1), and may delay recovery of RRC connection, thereby causing service interruption.

In addition, based on the existing techniques, if the terminal equipment 102 is not provided with a reference signal for radio link monitoring and is provided with TCI states associated with reception including one or more DCHs, each TCI state includes one or two reference signals, each of which being associated with the serving cell (cell 1 or other serving cells (in a case where carrier aggregation or dual connectivity is configured). For inter-cell beam management, the TCI state needs to be associated with the downlink dedicated channel of the non-serving cell (cell 2), and the existing mechanism is unable support such configuration, and is unable to achieve inter-cell beam management.

Various implementations of the embodiments of this disclosure shall be described below with reference to the accompanying drawings. These implementations are illustrative only, and are not intended to limit this disclosure.

### Embodiment 1

The embodiments of this disclosure provide an inter-cell beam management method. The method is applicable to a terminal equipment, such as the terminal equipment 102 in FIGS. 1-3.

FIG. 4 is a schematic diagram of the inter-cell beam management method of embodiment 1 of this disclosure. As shown in FIG. 4, the method includes:
step 401: receiving configuration of a beam of a non-serving cell from a network device; and
step 402: performing radio link failure detection by using a reference signal configured by the network device for radio link failure detection; or,
step 403: performing radio link failure detection by using a reference signal of a TCI state with which a serving cell is associated.

Hence, the terminal equipment uses the reference signal configured by the network device for radio link failure detection to perform radio link failure detection upon receiving configuration of a beam of a non-serving cell from the network device, or uses the reference signal of a TCI state associated with the serving cell for radio link failure detection. Thus, in inter-cell beam management, radio link failure detection of the serving cell may be performed, so as to avoid delays in RRC connection recovery and service interruptions, thereby ensuring system performances.

In the embodiments of this disclosure, after step 401, one of steps 402 and 403 may be executed. For example, in a case where the configuration of the reference signal for radio link failure detection is received from the network device, step 402 is executed, and in a case where the configuration of the reference signal for radio link failure detection is not received from the network device, step 403 is executed.

In the embodiments of this disclosure, when the terminal equipment is configured with carrier aggregation, the serving cell may include a special cell and/or a primary cell; when the terminal equipment is configured with dual connectivity, the serving cell may include at least one of a special cell, a primary cell of a primary cell group and a primary secondary cell of a secondary cell group; and when the terminal equipment is configured with carrier aggregation and dual connectivity, the serving cell may include at least one of a special cell, a primary cell of a primary cell group, and a primary secondary cell of a secondary cell group.

In the embodiments of this disclosure, the non-serving cell refers to a cell other than the serving cell.

In step 401, the terminal equipment receives the configuration of the beam of the non-serving cell from the network device, that is, the network device configures the beam of the non-serving cell for the terminal equipment.

That is, the terminal equipment receives configuration of a beam of a cell other than the serving cell from the network device, i.e. the network device configures a beam of a cell other than the serving cell for the terminal equipment.

FIG. 5 is a schematic diagram of a method for achieving step 401 of embodiment 1 of this disclosure. As shown in FIG. 5, the method includes:

step 501: receiving reference signal information of inter-cell beam management and/or cell information of inter-cell beam management from the network device; and/or, step 502: receiving TCI state information of the non-serving cell from the network device.

In the embodiments of this disclosure, at least one of steps 501 and 502 may be executed. And furthermore, when both steps 501 and 502 are executed, an order of execution of the two steps is not limited.

In the embodiments of this disclosure, the reference signal information of inter-cell beam management and/or the cell information of inter-cell beam management is/are information corresponding to a cell. That is, the reference signal information of inter-cell beam management and/or the cell information of inter-cell beam management is/are cell-level information.

In the embodiments of this disclosure, the reference signal of the reference signal information of inter-cell beam management may include an SSB and/or a CSI-RS.

In this case, for example, the reference signal information of inter-cell beam management includes an SSB index and/or a CSI-RS identity from the non-serving cell, that is, the reference signal information of inter-cell beam management includes an SSB index and/or a CSI-RS identity from the cell other than the serving cell.

In the embodiments of this disclosure, the cell information may include a physical cell identity (PCI).

In this case, for example, the cell information of inter-cell beam management includes a physical cell identity of the non-serving cell, that is, the cell information of inter-cell beam management includes a physical cell identity of the cell other than the serving cell.

In step 502, the terminal equipment receives the TCI state information of the non-serving cell from the network device, that is, the network device transmits the TCI state information of the non-serving cell to the terminal equipment.

That is, the terminal equipment receives TCI state information of a cell other than the serving cell from the network device, i.e. the network device provides the TCI state information of the cell other than the serving cell to the terminal equipment.

In this way, inter-cell beam management may be achieved when a terminal equipment is not provided with a reference signal for radio link monitoring and is provided with a TCI state associated with reception including one or more downlink dedicated channels.

In the embodiments of this disclosure, the TCI state information may be unified TCI state information, or TCI state information associated with PDCCH reception, or downlink TCI state information.

In the embodiments of this disclosure, the TCI state information of the non-serving cell, for example, includes that the TCI state information of the non-serving cell is associated with the reference signal information of inter-cell beam management and/or the cell information of inter-cell beam management (the above cell-level information), or that the TCI state information of the non-serving cell includes reference signal information of inter-cell beam management and/or cell information of inter-cell beam management (such as a physical cell identity), or that the TCI state information of the non-serving cell includes one or more QCL types. For example, the TCI state information of the non-serving cell includes two QCL types.

In the embodiments of this disclosure, the QCL type applies QCL information, the QCL information including an index field of the serving cell and the cell information or reference signal of the non-serving cell.

In this case, the terminal equipment applies the cell information or reference signal of the non-serving cell, and/or ignores the index field of the serving cell.

For example, one QCL type applies the QCL information, the QCL information including an index field of the serving cell, which denotes a serving cell of a terminal equipment configured with a reference signal, and if this field is absent, it is applicable to the serving cell configuring the TCI state;

furthermore, the QCL information may include a PCI or reference signal of the non-serving cell or a cell other than the serving cell, and terminal equipment applies this information and ignores the index field of the serving cell included in the QCL information.

For example, regarding the configuration for the TCI state by the RRC, the modification of a TCI state IE (TCI-State information element) may be adding a new field.

For example, marking an ASN.1 data format by the TCI state IE by using an abstract syntax may be expressed as:

TCI-State information element

| -- ASN1START | |
|---|---|
| -- TAG-TCI-STATE-START | |
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| physCellId | PhysCellId |
| OPTIONAL, Cond ICBM-Config | |
| bwp-Id | BWP-Id |
| OPTIONAL, -- Cond CSI-RS-Indicated | |
| referenceSignal | CHOICE { |
| csi-rs | NZP-CSI-RS- |
| ResourceId, | |
| ssb | SSB-Index |
| }, | |
| qcl-Type | ENUMERATED {typeA, |

typeB, typeC, typeD},
...
}
-- TAG-TCI-STATE-STOP
-- ASN1STOP

Description of the newly-added field is as follows:

Description of the QCL-Info field

bwp-Id
A DL BWP where the reference signal RS is located
cell
A serving cell of the UE, in which a reference signal is configured.
If the field does not exist, it is applicable to a serving cell configured
with the TCI-State. The reference signal can be located on a serving cell
other than the serving cell configured with the TCI-State only when qcl-
Type is configured as typeC or typeD. See sub-article 5.1.5 of TS 38.214
[19].
referenceSignal
A reference signal providing quasi-colocation information, as described in
sub-article 5.1.5 of TS 38.214 [19].
qcl-Type
A QCL type, as described in sub-article 5.1.5 of TS 38.214 [19].

| Conditional existence | Interpretation |
|---|---|
| CSI-RS-Indicated | If a csi-rs is contained, the field necessarily exists; |
| | otherwise, it does not exist. |
| ICBM-Config | If IE1/field1 is contained, the field is optional, |
| | and N is needed; otherwise, it does not exist. |

Here, IE1 or field1 is an IE or field of a beam or reference signal or cell identity or TCI state of a non-serving cell (a cell other than the serving cell) introduced for inter-cell beam management, or an IE or field in which it is located.

Additionally, if TCI-State or QCL-Info includes physCellId, the terminal equipment applies a value of this field and ignores the cell field.

The above example is to add a new field, and description of an existing field may be modified, which is as shown below:

For example, the TCI state IE uses an existing field, and marking an ASN.1 data format by it by using an abstract syntax may be expressed as:

TCI-State information element

| -- ASN1START | |
|---|---|
| -- TAG-TCI-STATE-START | |
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS- |
| ResourceId, | |
| ssb | SSB-Index |
| }, | |
| qcl-Type | ENUMERATED {typeA, |

typeB, typeC, typeD},
...
}
-- TAG-TCI-STATE-STOP
-- ASN1STOP

The description of the existing field is modified as follows:

Description of the QCL-Info field

bwp-Id
A DL BWP where the reference signal RS is located
cell
A serving cell of the UE, in which a reference signal is configured.
If the field does not exist, it is applicable to a serving cell configured
with the TCI-State. The reference signal can be located on a serving cell
other than the serving cell configured with the TCI-State only when qcl-
Type is configured as typeC or typeD. See sub-article 5.1.5 of TS 38.214
[19].
referenceSignal
A reference signal providing quasi-colocation information, as described in
sub-article 5.1.5 of TS 38.214 [19]. If the reference signal is from
a cell associated with the serving cell, the field cell is ignored.
qcl-Type
A QCL type, as described in sub-article 5.1.5 of TS 38.214 [19].

| Conditional | |
|---|---|
| existence | Interpretation |
| CSI-RS- | If a csi-rs is contained, the field necessarily exists; |
| Indicated | otherwise, it does not exist. |

Contents related to the configuration of the beam of the non-serving cell in step 401 are described above.

In step 402, radio link failure detection is performed by using the reference signal configured by the network device for radio link failure detection.

That is, if the network device configures the beam of the non-serving cell (a cell other than the serving cell) for the terminal equipment, the network device will or shall provide a reference signal for radio link failure detection for the terminal.

In the embodiments of this disclosure, the reference signal for radio link failure detection may include: a reference signal used by the terminal equipment in performing radio link monitoring; and/or, a reference signal for radio link monitoring with a purpose set to be “radio link failure” or “both” in a failure detection resource addition modification list.

For example, the reference signal used by the terminal equipment in performing radio link monitoring includes at least one of the following:
an SSB configured for an initial downlink BWP of a special cell;
an SSB configured for a downlink BWP of the special cell including an SSB with which the initial downlink BWP is associated; and
a CSI-RS configured for a downlink BWP of the special cell.

For example, the reference signal for radio link monitoring with a purpose set to be “radio link failure” or “both” in the failure detection resource addition modification list is RadioLinkMonitoringRS of failure DetectionResourcesToAddModList, and its purpose, i.e. purpose field, is set to be “rif” or “both”.

For step 402, for example, the RRC configuration IE is modified, and marking an ASN.1 data format by using an abstract syntax may be expressed as:

RadioLinkMonitoringConfig information element

-- ASN1START
-- TAG-RADIOLINKMONITORINGCONFIG-START

| | |
|---|---|
| RadioLinkMonitoringConfig ::= | SEQUENCE { |
| failureDetectionResourcesToAddModList | SEQUENCE |
| (SIZE(1..maxNrofFailureDetectionResources)) | OF |

RadioLinkMonitoringRS
OPTIONAL, -- [symbol] Cond ICBM

| | |
|---|---|
| failureDetectionResourcesToReleaseList | SEQUENCE |
| (SIZE(1..maxNrofFailureDetectionResources)) | OF |

RadioLinkMonitoringRS-Id
OPTIONAL, -- Need N

| | |
|---|---|
| beamFailureInstanceMaxCount | ENUMERATED {n1, n2, |
| n3, n4, n5, n6, n8, n10} | OPTIONAL, -- |

Need R

| | |
|---|---|
| beamFailureDetectionTimer | ENUMERATED {pbfd1, |
| pbfd2, pbfd3, pbfd4, pbfd5, pbfd6, pbfd8, pbfd10} | OPTIONAL, -- |

Need R
...
}

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, |

rlf, both},

| | |
|---|---|
| detectionResource | CHOICE { |
| ssb-Index | SSB-Index, |
| csi-RS-Index | NZP-CSI-RS-ResourceId |

```
  },
  ...
}
-- TAG-RADIOLINKMONITORINGCONFIG-STOP
-- ASN1STOP
```

The description of the existing field is modified as follows:

Description of the RadioLinkMonitoringConfig field

beamFailureDetectionTimer
A beam failure detection timer (see Sub-article 5.17 of TS 38.321 [3]). And reference may
further be made to BeamFailureRecoveryConfig IE. A number value of “a Q_{out, LR} reporting
period of a beam failure detection reference signal” (see Article 6 of TS 38.213 [13]). A value
pbfd1 corresponds to a Q_{out, LR} reporting period of a beam failure detection reference signal, a
value pbfd2 corresponds to Q_{out, LR} reporting periods of two beam failure detection reference
signals, and so on.
beamFailureInstanceMaxCount
This field determines the number of beam failure events after which the UE triggers beam
failure recovery (see Sub-article 5.17 of TS 38.321 [3]). A value n1 corresponds to one beam
failure instance, a value n2 corresponds to two beam failure instances, and so on.
failureDetectionResourcesToAddModList
A reference signal list for detecting beam failures and/or cell-level radio link failures (RLFs).
Limitations on the reference signals that may be configured by the network device are specified
in Table 5-1 of TS 38.213 [13]. The network device configures at most two detection resources
for the beam failure or both for each BWP. If no reference signal is provided for the purpose of
beam failure detection, the UE performs beam monitoring based on an active TCI-State with
which a PDCCH is associated, as described in section 6 of TS 38.213 [13]. If no reference
signal is provided for the purpose of beam failure detection in the list, the UE performs cell-
RLM based on the active TCI-State with which the PDCCH is associated, as described in
Article 5 of TS 38.213 [13]. The network ensures that the UE has a group of applicable
reference signals for performing cell-RLM.

Description of the RadioLinkMonitoringRS field

detectionResource
The UE will use the reference signals for radio link monitoring or beam
failure detection (depending on a purpose of indication). A periodicity 1
port CSI-RS may only be configured on the SCell for beam failure
detection.
purpose
Whether the UE should monitor associated reference signals for the
purpose of cell and/or beam failure detection is determined. For the
SCell, the network only configures a value of a beam failure
(beamFailure).

| Conditional | |
|---|---|
| existence | Interpretation |
| ICBM | If IE1/field1 is/are contained, the field necessarily exists; |
| | otherwise, it is optional, and R is needed. |

Here, IE1 or field1 is an IE or field of a beam or reference signal or cell identity or TCI state of a non-serving cell (a cell other than the serving cell) introduced for inter-cell beam management, or an IE or field in which it is located.

The example shown above is to modify an existing field, and a new field may further be added to indicate addition and/or modification of a failure detection resource list in Rel-17, such as failure DetectionResourcesToAddModList-r17, and marking an ASN.1 data format by using an abstract syntax may be expressed as:

RadioLinkMonitoringConfig information element

-- ASN1START
-- TAG-RADIOLINKMONITORINGCONFIG-START

| | |
|---|---|
| RadioLinkMonitoringConfig ::= | SEQUENCE { |
| failureDetectionResourcesToAddModList | SEQUENCE |

(SIZE(1..maxNrofFailureDetectionResources)) OF RadioLinkMonitoringRS
OPTIONAL, -- Need N

| | |
|---|---|
| failureDetectionResourcesToReleaseList | SEQUENCE |

(SIZE(1..maxNrofFailureDetectionResources)) OF RadioLinkMonitoringRS-
Id
OPTIONAL, -- Need N

| | |
|---|---|
| FailureDetectionResourcesToReleaseList-r17 | SEQUENCE |

(SIZE(1..maxNrofFailureDetectionResources)) OF RadioLinkMonitoringRS-
Id OPTIONAL --Cond ICBM

| | |
|---|---|
| beamFailureInstanceMaxCount | ENUMERATED {n1, n2, n3, |
| n4, n5, n6, n8, n10} | OPTIONAL, -- Need R |
| beamFailureDetectionTimer | ENUMERATED {pbfd1, pbfd2, |
| pbfd3, pbfd4, pbfd5, pbfd6, pbfd8, pbfd10} | OPTIONAL, -- Need R |

...
}

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, rlf, |
| both}, | |
| detectionResource | CHOICE { |
| ssb-Index | SSB-Index, |
| csi-RS-Index | NZP-CSI-RS-ResourceId |

```
  },
  ...
}
-- TAG-RADIOLINKMONITORINGCONFIG-STOP
-- ASN1STOP
```

The description of the existing field is modified as follows:

Description of the RadioLinkMonitoringConfig field

beamFailureDetectionTimer
A beam failure detection timer (see Sub-article 5.17 of TS 38.321 [3]). And reference may
further be made to BeamFailureRecoveryConfig IE. A number value of “a Q_{out, LR} reporting
period of a beam failure detection reference signal” (see Article 6 of TS 38.213 [13]). A value
pbfd1 corresponds to a Q_{out, LR} reporting period of a beam failure detection reference signal, a
value pbfd2 corresponds to Q_{out, LR} reporting periods of two beam failure detection reference
signals, and so on.
beamFailureInstanceMaxCount
This field determines the number of beam failure events after which the UE triggers beam
failure recovery (see Sub-article 5.17 of TS 38.321 [3]). A value n1 corresponds to one beam
failure instance, a value n2 corresponds to two beam failure instances, and so on.
failureDetectionResourcesToAddModList, failureDetectionResourcesToAddModList-r17
A reference signal list for detecting beam failures and/or cell-level radio link failures (RLFs).
Limitations on the reference signals that may be configured by the network device are specified
in Table 5-1 of TS 38.213 [13]. The network device configures at most two detection resources
for the beam failure or both for each BWP. If no reference signal is provided for the purpose of
beam failure detection, the UE performs beam monitoring based on an active TCI-State with
which a PDCCH is associated, as described in section 6 of TS 38.213 [13]. If no reference
signal is provided for the purpose of RLF detection in the list, the UE performs cell-RLM
based on the active TCI-State with which the PDCCH is associated, as described in Article 5 of
TS 38.213 [13]. The network ensures that the UE has a group of applicable reference signals
for performing cell-RLM.

Description of the RadioLinkMonitoringRS field

detectionResource
The UE will use the reference signals for radio link monitoring or
beam failure detection (depending on a purpose of indication). A
periodicity 1 port CSI-RS may only be configured on the SCell
for beam failure detection.
purpose
Whether the UE should monitor associated reference signals for the
purpose of cell and/or beam failure detection is determined. For
the SCell, the network only configures a value of a beam failure
(beamFailure).

| Conditional | |
|---|---|
| existence | Interpretation |
| ICBM | If IE1/field1 is/are contained, the field necessarily exists; |
| | otherwise, it is optional, and R is needed. |

In step 403, radio link failure detection is performed by using the reference signal of the TCI state associated with the serving cell.

That is, if the network device configures a beam of the non-serving cell (a cell other than the serving cell) for the terminal and does not provide a reference signal for radio link failure detection, the reference signal of the TCI state associated with the serving cell is used for radio link failure detection.

In the embodiments of this disclosure, the non-serving cell may be associated with the serving cell.

In the embodiments of this disclosure, the reference signal of the TCI state associated with the serving cell may be a reference signal of an active TCI state associated with the serving cell. That is, radio link failure detection is performed by using the reference signal of the active TCI state associated with the serving cell.

For example, the TCI state is a unified TCI state, or a TCI state with which PDCCH reception is associated, or a downlink TCI state.

In the embodiments of this disclosure, the TCI state associated with the serving cell may include a reference signal of a serving cell and/or cell information of a serving cell; or, the TCI state associated with the serving cell is associated with a reference signal of a serving cell.

For example, that the TCI state associated with the serving cell is associated with a reference signal of a serving cell includes that the TCI state associated with the serving cell includes one or more QCL types.

In the embodiments of this disclosure, the QCL type applies QCL information, the QCL information including an index field of the serving cell and cell information or a reference signal of the non-serving cell.

In this case, the terminal equipment applies the cell information or reference signal of the non-serving cell, and/or ignores the index field of the serving cell.

For example, one QCL type applies the QCL information, the QCL information including an index field of the serving cell, which denotes a serving cell of a terminal equipment configured with a reference signal, and if this field is absent, it is applicable to the serving cell configuring the TCI state;

furthermore, the QCL information may include a PCI or reference signal of the non-serving cell or a cell other than the serving cell, and terminal equipment applies this information and ignores the index field of the serving cell included in the QCL information.

Specific modified contents of the TCI State Information Element (IE) may be identical to those described above, which shall not be repeated herein any further.

In step 403, it may also be that radio link failure detection is performed by using the reference signal of the TCI state associated with the serving cell, until the terminal equipment communicates with the network by using the beam of the non-serving cell associated with the serving cell.

That is, if the network device configures the terminal equipment with a beam of the non-serving cell (a cell other than the serving cell) and if the network device does not provide a reference signal for radio link failure detection, the reference signal of the TCI state associated with the serving cell is used for radio link failure detection, until the terminal equipment communicates with the network by using the beam of the non-serving cell associated with the serving cell. Or, if the network device configures the terminal equipment with a beam of the non-serving cell (a cell other than the serving cell) and if the network device does not provide a reference signal for radio link failure detection, the reference signal of the active TCI state associated with the serving cell is use for radio link failure detection, until the terminal equipment communicates with the network by using the beam of the non-serving cell associated with the serving cell.

In the embodiments of this disclosure, that the terminal equipment communicates with the network by using the beam of the non-serving cell associated with the serving cell may include that the network device configures the beam of the non-serving cell (a cell other than the serving cell) for the terminal, and details thereof are as described above, which shall not be repeated here any further.

In the embodiments of this disclosure, that the terminal equipment communicates with the network by using the beam of the non-serving cell associated with the serving cell may further include that the beam of the non-serving cell is associated with a serving cell.

For example, that the beam of the non-serving cell is associated with a serving cell includes that the beam of the non-serving cell is included in configuration of a serving cell, or, the beam of the non-serving cell includes cell information of a serving cell.

In the embodiments of this disclosure, the cell information of a serving cell includes, for example, an identity of the serving cell, such as at least one of a serving cell index (ServCellIndex), a physical cell identity (PCI) and a cell identity (cellIdentify).

In the embodiments of this disclosure, that the terminal equipment communicates with the network by using the beam of the non-serving cell associated with the serving cell may further include that the network device activates the TCI state associated with the beam via L1 information and/or an MAC CE.

For step 403, for example, the RRC configuration IE is modified, and marking an ASN.1 data format by using an abstract syntax may be expressed as:

RadioLinkMonitoringConfig information element

-- ASNISTART
-- TAG-RADIOLINKMONITORINGCONFIG-START

| | |
|---|---|
| RadioLinkMonitoringConfig ::= | SEQUENCE { |
| failureDetectionResourcesToAddModList | SEQUENCE |

(SIZE(1..maxNrofFailureDetectionResources)) OF RadioLinkMonitoringRS
OPTIONAL, -- [symbol] Cond ICBM

| | |
|---|---|
| failureDetectionResourcesToReleaseList | SEQUENCE |

(SIZE(1..maxNrofFailureDetectionResources)) OF RadioLinkMonitoringRS-
Id
OPTIONAL, -- Need N

| | |
|---|---|
| beamFailureInstanceMaxCount | ENUMERATED {n1, n2, n3, |
| n4, n5, n6, n8, n10} | OPTIONAL, -- Need R |
| beamFailureDetectionTimer | ENUMERATED {pbfd1, pbfd2, |
| pbfd3, pbfd4, pbfd5, pbfd6, pbfd8, pbfd10} | OPTIONAL, -- Need R |

...
}

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, rlf, |

both},

| | |
|---|---|
| detectionResource | CHOICE { |
| ssb-Index | SSB-Index, |
| csi-RS-Index | NZP-CSI-RS-ResourceId |

```
  },
  ...
}
-- TAG-RADIOLINKMONITORINGCONFIG-STOP
-- ASN1STOP
```

The description of the existing field is modified as follows:

Description of the RadioLinkMonitoringConfig field

beamFailureDetectionTimer
A beam failure detection timer (see Sub-article 5.17 of TS 38.321 [3]). And reference may
further be made to BeamFailureRecoveryConfig IE. A number value of “a Q_{out, LR} reporting
period of a beam failure detection reference signal” (see Article 6 of TS 38.213 [13]). A value
pbfd1 corresponds to a Q_{out, LR} reporting period of a beam failure detection reference signal, a
value pbfd2 corresponds to Q_{out, LR} reporting periods of two beam failure detection reference
signals, and so on.
beamFailureInstanceMaxCount
This field determines the number of beam failure events after which the UE triggers beam
failure recovery (see Sub-article 5.17 of TS 38.321 [3]). A value n1 corresponds to one beam
failure instance, a value n2 corresponds to two beam failure instances, and so on.
failureDetectionResourcesToAddModList
A reference signal list for detecting beam failures and/or cell-level radio link failures (RLFs).
Limitations on the reference signals that may be configured by the network device are specified
in Table 5-1 of TS 38.213 [13]. The network device configures at most two detection resources
for the beam failure or both for each BWP. If no reference signal is provided for the purpose of
beam failure detection, the UE performs beam monitoring based on an active TCI-State with
which a PDCCH is associated, as described in section 6 of TS 38.213 [13]. If no reference
signal is provided for the purpose of RLF detection in the list, the UE performs cell-RLM
based on the active TCI-State with which the PDCCH on the serving cell is associated (if the
TCI-State is activated), as described in Article 5 of TS 38.213 [13]. The network ensures that
the UE has a group of applicable reference signals for performing cell-RLM.

Description of the RadioLinkMonitoringRS field

detectionResource
The UE will use the reference signals for radio link monitoring or
beam failure detection (depending on a purpose of indication). A
periodicity 1 port CSI-RS may only be configured on the SCell
for beam failure detection.
purpose
Whether the UE should monitor associated reference signals for the
purpose of cell and/or beam failure detection is determined. For
the SCell, the network only configures a value of a beam failure
(beamFailure).

A case to which the above example corresponds is that: when the terminal equipment communicates by using the beam of the non-serving cell, it no longer monitors a radio link monitoring reference signal (RLM RS) of the serving cell. The “if the TCI state is activated” above may also be expressed as “if the UE uses the PDCCH for communication”, or may be reversely expressed as “until the TCI state is not activated”, “until the UE does not use the PDCCH for communication”, “until the TCI state of PDCCH on a cell associated with the serving cell is activated”, “until the UE uses the PDCCH on a cell associated with the serving cell for communication”, or may be expressed otherwise.

In addition, when the terminal equipment communicates by using the beam of the non-serving cell, the terminal equipment may continue to monitor a radio link monitoring reference signal (RLM RS) of the serving cell, and marking an ASN.1 data format by using an abstract syntax may be expressed as:

RadioLinkMonitoringConfig information element

-- ASN1START
-- TAG-RADIOLINKMONITORINGCONFIG-START

| | |
|---|---|
| RadioLinkMonitoringConfig ::= | SEQUENCE { |
| failureDetectionResourcesToAddModList | SEQUENCE |
| (SIZE(1..maxNrofFailureDetectionResources)) | OF |

RadioLinkMonitoringRS
OPTIONAL, -- [symbol] Cond ICBM

| | |
|---|---|
| failureDetectionResourcesToReleaseList | SEQUENCE |
| (SIZE(1..maxNrofFailureDetectionResources)) | OF |

RadioLinkMonitoringRS-Id
OPTIONAL, -- Need N

| | |
|---|---|
| beamFailureInstanceMaxCount | ENUMERATED {n1, n2, |
| n3, n4, n5, n6, n8, n10} | OPTIONAL, -- |
| Need R | |
| beamFailureDetectionTimer | ENUMERATED {pbfd1, |
| pbfd2, pbfd3, pbfd4, pbfd5, pbfd6, pbfd8, pbfd10} | OPTIONAL, -- |

Need R
...
}

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, |

rlf, both},

| | |
|---|---|
| detectionResource | CHOICE { |
| ssb-Index | SSB-Index, |
| csi-RS-Index | NZP-CSI-RS-ResourceId |

```
  },
  ...
}
-- TAG-RADIOLINKMONITORINGCONFIG-STOP
-- ASN1STOP
```

The description of the existing field is modified as follows:

Description of the RadioLinkMonitoringConfig field

beamFailureDetectionTimer
A beam failure detection timer (see Sub-article 5.17 of TS 38.321 [3]). And reference may
further be made to BeamFailureRecoveryConfig IE. A number value of “a Q_{out, LR} reporting
period of a beam failure detection reference signal” (see Article 6 of TS 38.213 [13]). A value
pbfd1 corresponds to a Q_{out, LR} reporting period of a beam failure detection reference signal, a
value pbfd2 corresponds to Q_{out, LR} reporting periods of two beam failure detection reference
signals, and so on.
beamFailureInstanceMaxCount
This field determines the number of beam failure events after which the UE triggers beam
failure recovery (see Sub-article 5.17 of TS 38.321 [3]). A value n1 corresponds to one beam
failure instance, a value n2 corresponds to two beam failure instances, and so on.
failureDetectionResourcesToAddModList
A reference signal list for detecting beam failures and/or cell-level radio link failures (RLFs).
Limitations on the reference signals that may be configured by the network device are specified
in Table 5-1 of TS 38.213 [13]. The network device configures at most two detection resources
for the beam failure or both for each BWP. If no reference signal is provided for the purpose of
beam failure detection, the UE performs beam monitoring based on an active TCI-State with
which a PDCCH is associated, as described in section 6 of TS 38.213 [13]. If no reference
signal is provided for the purpose of RLF detection in the list, the UE performs cell-RLM
based on the active TCI-State with which the PDCCH on the serving cell is associated, as
described in Article 5 of TS 38.213 [13]. The network ensures that the UE has a group of
applicable reference signals for performing cell-RLM.

Description of the RadioLinkMonitoringRS field

detectionResource
The UE will use the reference signals for radio link monitoring or
beam failure detection (depending on a purpose of indication). A
periodicity 1 port CSI-RS may only be configured on the SCell
for beam failure detection.
purpose
Whether the UE should monitor associated reference signals for the
purpose of cell and/or beam failure detection is determined. For
the SCell, the network only configures a value of a beam failure
(beamFailure).

In this case, if the network device configures the terminal equipment with multiple TCI states, the terminal equipment uses the PDCCH to receive corresponding TCI states; and when the terminal equipment uses a PDCCH of the non-serving cell to receive a TCI state, the reference signal (RS) included in the previously used TCI state of the serving cell is used for RLF detection, that is, it serves as the reference signal for radio link monitoring (RLM RS).

It can be seen from the above embodiment that the terminal equipment uses the reference signal configured by the network device for radio link failure detection to perform radio link failure detection upon receiving configuration of a beam of a non-serving cell from the network device, or uses the reference signal of the TCI state associated with the serving cell for radio link failure detection. Hence, in inter-cell beam management, radio link failure detection of the serving cell may be performed, so as to avoid delays in RRC connection recovery and service interruptions, thereby ensuring system performances.

### Embodiment 2

The embodiments of this disclosure provide an inter-cell beam management method. The method is applicable to a network device, and corresponds to the inter-cell beam management method applicable to a terminal equipment described in embodiment 1, with identical contents being not going to be described herein any further.

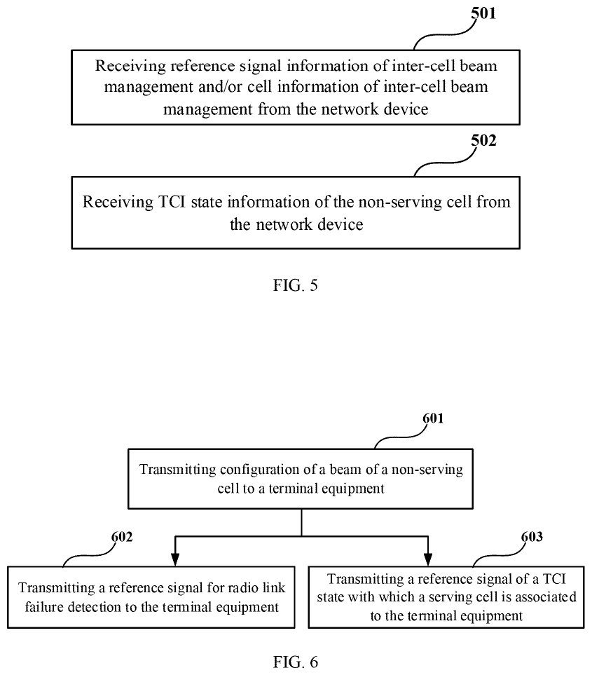

FIG. 6 is a schematic diagram of the inter-cell beam management method of embodiment 2 of this disclosure. As shown in FIG. 6, the method includes:
step 601: transmitting configuration of a beam of a non-serving cell to a terminal equipment; and
step 602: transmitting a reference signal for radio link failure detection to the terminal equipment; and/or,
step 603: transmitting a reference signal of a TCI state with which a serving cell is associated to the terminal equipment.

In the embodiments of this disclosure, at least one of steps 602 and 603 may be executed, and when both steps 602 and 603 are executed, an order of execution thereof is not limited.

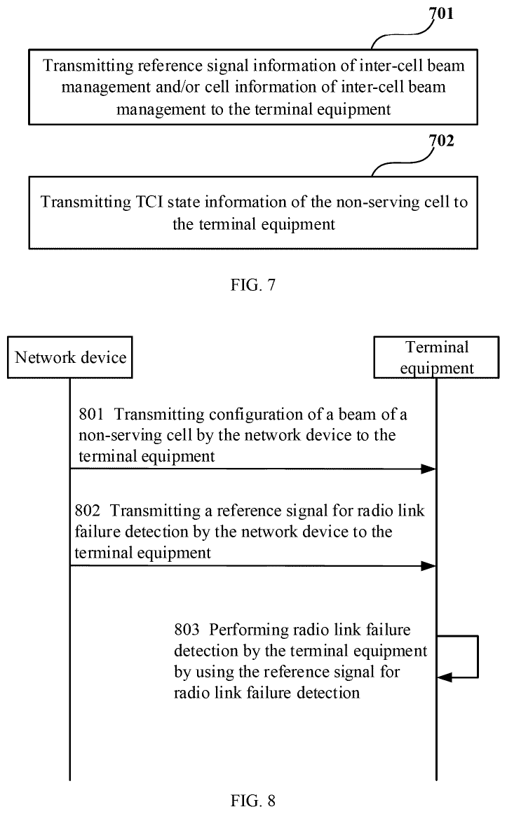

FIG. 7 is a schematic diagram of a method for achieving step 601 of embodiment 2 of this disclosure. As shown in FIG. 7, the method includes:
step 701: transmitting reference signal information of inter-cell beam management and/or cell information of inter-cell beam management to the terminal equipment; and/or,
step 702: transmitting TCI state information of the non-serving cell to the terminal equipment.

In the embodiments of this disclosure, at least one of steps 701 and 702 may be executed, and furthermore, when both steps 701 and 702 are executed, an order of execution thereof is not limited.

In the embodiments of this disclosure, the reference signal information of inter-cell beam management and/or the cell information of inter-cell beam management may be information corresponding to a cell, i.e. cell-level information.

In the embodiments of this disclosure, the reference signal of the reference signal information of the inter-cell beam management may include an SSB and/or a CSI-RS.

For example, the reference signal information of inter-cell beam management includes an SSB index and/or a CSI-RS identity from the non-serving cell.

In the embodiments of this disclosure, the cell information may include a physical cell identity.

For example, the cell information of the inter-cell beam management includes a physical cell identity of the non-serving cell.

In the embodiments of this disclosure, the TCI state information may be unified TCI state information, or TCI state information with which PDCCH reception is associated, or downlink TCI state information.

In the embodiments of this disclosure, the TCI state information of the non-serving cell may be associated with the reference signal information of inter-cell beam management and/or the cell information of inter-cell beam management; or, the TCI state information of the non-serving cell may include the reference signal information of inter-cell beam management and/or the cell information of inter-cell beam management; or, the TCI state information of the non-serving cell may include one or more QCL types.

For example, the QCL type applies QCL information, the QCL information including an index field of the serving cell and the cell information or reference signal of the non-serving cell.

In the embodiments of this disclosure, the reference signal for radio link failure detection may include: a reference signal used by the terminal equipment in performing radio link monitoring; and/or, a reference signal for radio link monitoring with a purpose set to be “radio link failure” or “both” in a failure detection resource addition modification list.

In the embodiments of this disclosure, the reference signal used by the terminal equipment in performing radio link monitoring includes at least one of the following: an SSB configured for an initial downlink BWP of a special cell; an SSB configured for a downlink BWP of the special cell including an SSB with which the initial downlink BWP is associated; and a CSI-RS configured for a downlink BWP of the special cell.

In the embodiments of this disclosure, the reference signal of the TCI state associated with the serving cell may be a reference signal of an active TCI state associated with the serving cell.

In the embodiments of this disclosure, the TCI state may be a unified TCI state, or a TCI state with which PDCCH reception is associated, or a downlink TCI state.

In the embodiments of this disclosure, the TCI state associated with the serving cell includes a reference signal of a serving cell and/or cell information of a serving cell; or, the TCI state associated with the serving cell may be associated with a reference signal of the serving cell.

In the embodiments of this disclosure, that the TCI state associated with the serving cell is associated with a reference signal of a serving cell may include that the TCI state associated with the serving cell includes one or more QCL types.

For example, the QCL type applies QCL information, the QCL information including an index field of the serving cell and the cell information or reference signal of the non-serving cell.

In the embodiments of this disclosure, reference may be made to related parts in embodiment 1 for specific contents concerning the network device, which shall not be repeated here any further.

It can be seen from the above embodiment that the terminal equipment uses the reference signal configured by the network device for radio link failure detection to perform radio link failure detection upon receiving configuration of a beam of a non-serving cell from the network device, or uses the reference signal of the TCI state associated with the serving cell for radio link failure detection. Hence, in inter-cell beam management, radio link failure detection of the serving cell may be performed, so as to avoid delays in RRC connection recovery and service interruptions, thereby ensuring system performances.

### Embodiment 3

The embodiments of this disclosure provide an inter-cell beam management method. The method is applicable to a network device and a terminal equipment, and corresponds to the inter-cell beam management method applicable to a terminal equipment described in embodiment 1 and the inter-cell beam management method applicable to a network device described in embodiment 2, with identical contents being not going to be described herein any further.

FIG. 8 is a schematic diagram of the inter-cell beam management method of embodiment 3 of this disclosure. As shown in FIG. 8, the method includes:
step 801: transmitting configuration of a beam of a non-serving cell by the network device to the terminal equipment;
step 802: transmitting a reference signal for radio link failure detection by the network device to the terminal equipment; and
step 803: performing radio link failure detection by the terminal equipment by using the reference signal for radio link failure detection.

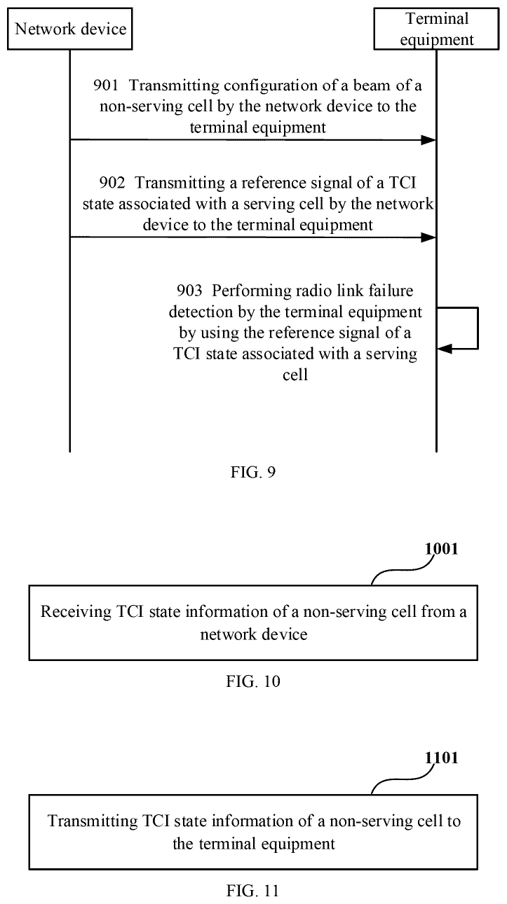

FIG. 9 is another schematic diagram of the inter-cell beam management method of embodiment 3 of this disclosure. As shown in FIG. 9, the method includes:
step 901: transmitting configuration of a beam of a non-serving cell by the network device to the terminal equipment;
step 902: transmitting a reference signal of a TCI state associated with a serving cell by the network device to the terminal equipment; and
step 903: performing radio link failure detection by the terminal equipment by using the reference signal of a TCI state associated with a serving cell.

In the embodiments of this disclosure, reference may be made to what is described in embodiments 1 and 2 for implementations of steps 801-803 and 901-903, which shall not be repeated herein any further.

It can be seen from the above embodiment that the terminal equipment uses the reference signal configured by the network device for radio link failure detection to perform radio link failure detection upon receiving configuration of a beam of a non-serving cell from the network device, or uses the reference signal of the TCI state associated with the serving cell for radio link failure detection. Hence, in inter-cell beam management, radio link failure detection of the serving cell may be performed, so as to avoid delays in RRC connection recovery and service interruptions, thereby ensuring system performances.

### Embodiment 4

The embodiments of this disclosure provide an inter-cell beam management method. The method is applicable to a terminal equipment, such as the terminal equipment 102 in FIGS. 1-3.

FIG. 10 is a schematic diagram of the inter-cell beam management method of embodiment 4 of this disclosure. As shown in FIG. 10, the method includes:
step 1001: receiving TCI state information of a non-serving cell from a network device.

That is, the network device transmits the TCI state information of the non-serving cell to a terminal equipment.

That is, the terminal equipment receives TCI state information of a cell other than the serving cell from the network device, i.e. the network device transmits the TCI state information of the cell other than the serving cell to the terminal equipment.

Thus, inter-cell beam management may be achieved in a case where a terminal equipment is not provided with a reference signal for radio link monitoring and is provided with TCI states associated with reception including one or more DCHs.

In the embodiments of this disclosure, the TCI state information may be unified TCI state information, or TCI state information associated with PDCCH reception, or downlink TCI state information.

In the embodiments of this disclosure, the TCI state information of the non-serving cell, for example, includes that the TCI state information of the non-serving cell is associated with the reference signal information of inter-cell beam management and/or the cell information of inter-cell beam management (the above cell-level information), or that the TCI state information of the non-serving cell includes reference signal information of inter-cell beam management and/or cell information of inter-cell beam management (such as a physical cell identity), or that the TCI state information of the non-serving cell includes one or more QCL types. For example, the TCI state information of the non-serving cell includes two QCL types.

In the embodiments of this disclosure, the QCL type applies QCL information, the QCL information including an index field of the serving cell and the cell information or reference signal of the non-serving cell.

In this case, the terminal equipment applies the cell information or reference signal of the non-serving cell, and/or ignores the index field of the serving cell.

For example, one QCL type applies the QCL information, the QCL information including an index field of the serving cell, which denotes a serving cell of a terminal equipment configured with a reference signal, and if this field is absent, it is applicable to the serving cell configuring the TCI state;
furthermore, the QCL information may include a PCI or reference signal of the non-serving cell or a cell other than the serving cell, and terminal equipment applies this information and ignores the index field of the serving cell included in the QCL information.

For example, regarding the configuration for the TCI state by the RRC, the modification of a TCI state IE (TCI-State information element) may be adding a new field.

For example, marking an ASN.1 data format by the TCI state IE by using an abstract syntax may be expressed as:

TCI-State information element

| -- ASN1START | |
|---|---|
| -- TAG-TCI-STATE-START | |
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| physCellId | PhysCellId |
| OPTIONAL, Cond ICBM-Config | |
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, |

typeC, typeD},
...
}
-- TAG-TCI-STATE-STOP
-- ASN1STOP

Description of the newly-added field is as follows:

Description of the QCL-Info field

bwp-Id
A DL BWP where the reference signal RS is located
cell
A serving cell of the UE, in which a reference signal is
configured. If the field does not exist, it is applicable
to a serving cell configured with the TCI-State. The
reference signal can be located on a serving cell other
than the serving cell configured with the TCI-State only
when qcl-Type is configured as typeC or typeD. See sub-
article 5.1.5 of TS 38.214 [19].
referenceSignal
A reference signal providing quasi-colocation information,
as described in sub-article 5.1.5 of TS 38.214 [19].
qcl-Type
A QCL type, as described in sub-article 5.1.5 of TS 38.214 [19].

| Conditional | |
|---|---|
| existence | Interpretation |
| CSI-RS- | If a csi-rs is contained, the field necessarily exists; |
| Indicated | otherwise, it does not exist. |
| ICBM-Config | If IE1/field1 is contained, the field is optional, and N |
| | is needed; otherwise, it does not exist. |

Here, IE1 or field1 is an IE or field of a beam or reference signal or cell identity or TCI state of a non-serving cell (a cell other than the serving cell) introduced for inter-cell beam management, or an IE or field in which it is located.

Additionally, if TCI-State or QCL-Info includes physCellId, the terminal equipment applies a value of this field and ignores the cell field.

The above example is to add a new field, and description of an existing field may be modified, which is as shown below:

For example, the TCI state IE uses an existing field, and marking an ASN.1 data format by it by using an abstract syntax may be expressed as:

TCI-State information element

| -- ASN1START | |
|---|---|
| -- TAG-TCI -STATE-START | |
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS- |
| ResourceId, | |
| ssb | SSB-Index |
| }, | |
| qcl-Type | ENUMERATED {typeA, |

typeB, typeC, typeD},
...
-- TAG-TCI -STATE-STOP
-- ASN1STOP

The description of the existing field is modified as follows:

Description of the QCL-Info field

bwp-Id
A DL BWP where the reference signal RS is located
cell
A serving cell of the UE, in which a reference signal is configured. If
the field does not exist, it is applicable to a serving cell configured
with the TCI-State. The reference signal can be located on a serving
cell other than the serving cell configured with the TCI-State only
when qcl-Type is configured as typeC or typeD. See sub-article 5.1.5
of TS 38.214 [19].
referenceSignal
A reference signal providing quasi-colocation information, as described
in sub-article 5.1.5 of TS 38.214 [19]. If the reference signal
is from a cell associated with the serving cell, the field cell is
ignored.
qcl-Type
A QCL type, as described in sub-article 5.1.5 of TS 38.214 [19].

| Conditional | |
|---|---|
| existence | Interpretation |
| CSI-RS- | If a csi-rs is contained, the field necessarily exists; |
| Indicated | otherwise, it does not exist. |

Reference may be made to what is described in embodiment 1 for other related contents, which shall not be repeated herein any further.

It can be seen from the above embodiment that the terminal equipment receives the TCI state information of the non-serving cell from the network device. Thus, inter-cell beam management may be achieved in a case where a terminal equipment is not provided with a reference signal for radio link monitoring and is provided with TCI states associated with reception including one or more DCHs.

### Embodiment 5

The embodiments of this disclosure provide an inter-cell beam management method. The method is applicable to a network device, and corresponds to the inter-cell beam management method applicable to a terminal equipment described in embodiment 4, with identical contents being not going to be described herein any further.

FIG. 11 is a schematic diagram of the inter-cell beam management method of embodiment 5 of this disclosure. As shown in FIG. 11, the method includes:
step 1101: transmitting TCI state information of a non-serving cell to the terminal equipment.

In the embodiments of this disclosure, the TCI state information may be unified TCI state information, or TCI state information associated with PDCCH reception, or downlink TCI state information.

In the embodiments of this disclosure, the TCI state information of the non-serving cell may be associated with reference signal information of inter-cell beam management and/or cell information of inter-cell beam management, or the TCI state information of the non-serving cell may include the reference signal information of inter-cell beam management and/or the cell information of inter-cell beam management, or the TCI state information of the non-serving cell may include one or more QCL types.

For example, the QCL type applies QCL information, the QCL information including an index field of the serving cell and the cell information or reference signal of the non-serving cell.

For example, the terminal equipment applies the cell information or reference signal of the non-serving cell, and/or ignores the index field of the serving cell.

In the embodiments of this disclosure, reference may be made to related parts in embodiment 1 for specific contents concerning the network device, which shall not be repeated here any further.

It can be seen from the above embodiment that the network device transmits the TCI state information of the non-serving cell to the terminal equipment. Thus, inter-cell beam management may be achieved in a case where a terminal equipment is not provided with a reference signal for radio link monitoring and is provided with TCI states associated with reception including one or more DCHs.

### Embodiment 6

The embodiments of this disclosure provide an inter-cell beam management apparatus, applicable to a terminal equipment. As a principle of the apparatus for solving problems is identical to that of the method in embodiment 1, reference may be made to the implementation of the method in embodiment 1 for implementation of the apparatus, with identical contents being not going to be repeated herein any further.

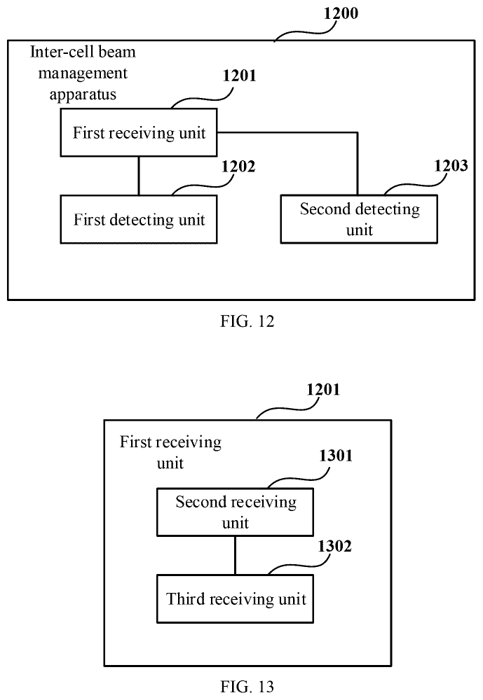

FIG. 12 is a schematic diagram of the inter-cell beam management apparatus of embodiment 6 of this disclosure. As shown in FIG. 12, an inter-cell beam management apparatus 1200 includes:
a first receiving unit 1201 configured to receive configuration of a beam of a non-serving cell from a network device; and
a first detecting unit 1202 configured to perform radio link failure detection by using a reference signal configured by the network device for radio link failure detection; or, a second detecting unit 1203 configured to perform radio link failure detection by using a reference signal of a TCI state with which a serving cell is associated.

FIG. 13 is a schematic diagram of the first receiving unit of embodiment 6 of this disclosure. As shown in FIG. 13, the first receiving unit 1201 includes:
a second receiving unit 1301 configured to receive reference signal information of inter-cell beam management and/or cell information of inter-cell beam management from the network device; and/or,
a third receiving unit 1302 configured to receive TCI state information of the non-serving cell from the network device.

In the embodiments of this disclosure, the reference signal information of inter-cell beam management and/or the cell information of inter-cell beam management may be information corresponding to a cell.

In the embodiments of this disclosure, the reference signal information of inter-cell beam management may include an SSB and/or a CSI-RS.

For example, the reference signal information of inter-cell beam management includes an SSB index and/or a CSI-RS identity from the non-serving cell.

In the embodiments of this disclosure, the cell information may include a physical cell identity.

For example, the cell information of inter-cell beam management includes a physical cell identity of the non-serving cell.

In the embodiments of this disclosure, the TCI state information of the non-serving cell may be associated with the reference signal information of inter-cell beam management and/or the cell information of inter-cell beam management; or, the TCI state information of the non-serving cell may include the reference signal information of inter-cell beam management and/or the cell information of inter-cell beam management; or, the TCI state information of the non-serving cell may include one or more QCL types.

For example, the QCL types apply QCL information, the QCL information including a serving cell index field, and cell information or a reference signal of the non-serving cell.

For example, the apparatus may further include: a first processing unit configured to apply the cell information or reference signal of the non-serving cell, and/or ignore the serving cell index field.

In the embodiments of this disclosure, the reference signal for radio link failure detection may include: a reference signal used by the terminal equipment in performing radio link monitoring; and/or, a reference signal for radio link monitoring with a purpose set to be “radio link failure” or “both” in a failure detection resource addition modification list.

In the embodiments of this disclosure, the reference signal used by the terminal equipment in performing radio link monitoring includes at least one of the following: an SSB configured for an initial downlink BWP of a special cell; an SSB configured for a downlink BWP of the special cell including an SSB with which the initial downlink BWP is associated; and a CSI-RS configured for a downlink BWP of the special cell.

In the embodiments of this disclosure, the reference signal of the TCI state with which the serving cell is associated is a reference signal of an active TCI state with which the serving cell is associated.

In the embodiments of this disclosure, the TCI state information may be unified TCI state information, or TCI state information associated with PDCCH reception, or downlink TCI state information.

In the embodiments of this disclosure, the TCI state associated with the serving cell may include a reference signal of a serving cell and/or cell information of a serving cell; or, the TCI state associated with the serving cell is associated with a reference signal of a serving cell.

In the embodiments of this disclosure, that the TCI state associated with the serving cell is associated with a reference signal of a serving cell may include that the TCI state associated with the serving cell includes one or more QCL types.

For example, the QCL type applies QCL information, the QCL information including an index field of the serving cell and cell information or a reference signal of the non-serving cell.

For example, the apparatus may further include: a second processing unit configured to apply the cell information or reference signal of the non-serving cell, and/or ignore the serving cell index field.

In the embodiments of this disclosure, the second detecting unit 1203 performs radio link failure detection by using the reference signal of the TCI state with which the serving cell is associated, until the terminal equipment communicates with a network by using a beam of the non-serving cell with which the serving cell is associated.

In the embodiments of this disclosure, the beam of the non-serving cell may be associated with a serving cell.

In the embodiments of this disclosure, that the beam of the non-serving cell may be associated with a serving cell may include that the beam of the non-serving cell is included in configuration of a serving cell, or the beam of the non-serving cell includes cell information of a serving cell.

In the embodiments of this disclosure, that the terminal equipment communicates with a network by using a beam of the non-serving cell with which the serving cell is associated may include that the network device, via L1 information and/or an MAC CE, activates the TCI state with which the beam is associated.

In the embodiments of this disclosure, reference may be made to relevant steps in embodiment 1 for functions of the above units, which shall not be repeated herein any further.

It can be seen from the above embodiment that the terminal equipment uses the reference signal configured by the network device for radio link failure detection to perform radio link failure detection upon receiving configuration of a beam of a non-serving cell from the network device, or uses the reference signal of the TCI state associated with the serving cell for radio link failure detection. Hence, in inter-cell beam management, radio link failure detection of the serving cell may be performed, so as to avoid delays in RRC connection recovery and service interruptions, thereby ensuring system performances.

### Embodiment 7

The embodiments of this disclosure provide an inter-cell beam management apparatus, applicable to a network device. As a principle of the apparatus for solving problems is identical to that of the method in embodiment 2, reference may be made to the implementation of the method in embodiment 2 for implementation of the apparatus, with identical contents being not going to be repeated herein any further.

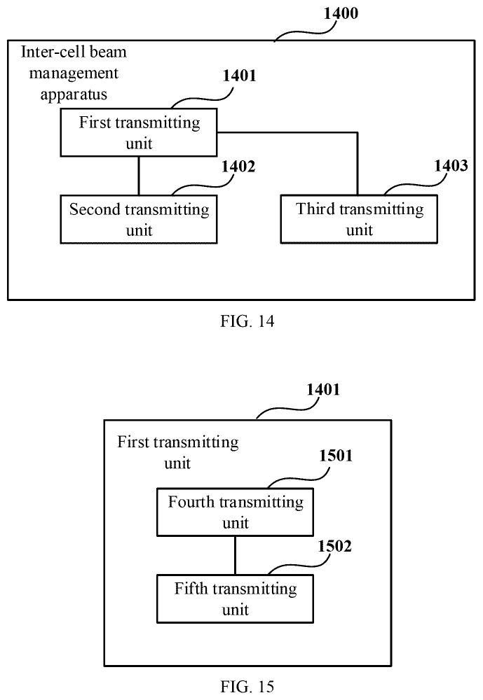

FIG. 14 is a schematic diagram of the inter-cell beam management apparatus of embodiment 7 of this disclosure. As shown in FIG. 14, an inter-cell beam management apparatus 1400 includes:
a first transmitting unit 1401 configured to transmit configuration of a beam of a non-serving cell to a terminal equipment; and
a second transmitting unit 1402 configured to transmit a reference signal for radio link failure detection to the terminal equipment; and/or, a third transmitting unit 1403 configured to transmit a reference signal of a TCI state with which a serving cell is associated to the terminal equipment.

FIG. 15 is a schematic diagram of the first transmitting unit of embodiment 7 of this disclosure. As shown in FIG. 15, the first transmitting unit 1401 includes:

a fourth transmitting unit 1501 configured to transmit reference signal information of inter-cell beam management and/or cell information of inter-cell beam management to the terminal equipment; and/or,
a fifth transmitting unit 1502 configured to transmit TCI state information of the non-serving cell to the terminal equipment.

In the embodiments of this disclosure, the reference signal information of inter-cell beam management and/or the cell information of inter-cell beam management may be information corresponding to a cell.

In the embodiments of this disclosure, the reference signal information of inter-cell beam management may include an SSB and/or a CSI-RS.

For example, the reference signal information of inter-cell beam management includes an SSB index and/or a CSI-RS identity from the non-serving cell.

In the embodiments of this disclosure, the cell information may include a physical cell identity.

For example, the cell information of inter-cell beam management includes a physical cell identity of the non-serving cell.

In the embodiments of this disclosure, the TCI state information may be unified TCI state information, or TCI state information associated with PDCCH reception, or downlink TCI state information.

In the embodiments of this disclosure, the TCI state information of the non-serving cell may be associated with the reference signal information of inter-cell beam management and/or the cell information of inter-cell beam management; or, the TCI state information of the non-serving cell may include the reference signal information of inter-cell beam management and/or the cell information of inter-cell beam management; or, the TCI state information of the non-serving cell may include one or more QCL types.

For example, the QCL types apply QCL information, the QCL information including a serving cell index field, and cell information or a reference signal of the non-serving cell.

In the embodiments of this disclosure, the reference signal for radio link failure detection may include: a reference signal used by the terminal equipment in performing radio link monitoring; and/or, a reference signal for radio link monitoring with a purpose set to be “radio link failure” or “both” in a failure detection resource addition modification list.

In the embodiments of this disclosure, the reference signal used by the terminal equipment in performing radio link monitoring includes at least one of the following: an SSB configured for an initial downlink BWP of a special cell; an SSB configured for a downlink BWP of the special cell including an SSB with which the initial downlink BWP is associated; and a CSI-RS configured for a downlink BWP of the special cell.

In the embodiments of this disclosure, the reference signal of the TCI state with which the serving cell is associated is a reference signal of an active TCI state with which the serving cell is associated.

In the embodiments of this disclosure, the TCI state information may be unified TCI state information, or TCI state information associated with PDCCH reception, or downlink TCI state information.

In the embodiments of this disclosure, the TCI state associated with the serving cell may include a reference signal of a serving cell and/or cell information of a serving cell; or, the TCI state associated with the serving cell is associated with a reference signal of a serving cell.

In the embodiments of this disclosure, that the TCI state associated with the serving cell is associated with a reference signal of a serving cell may include that the TCI state associated with the serving cell includes one or more QCL types.

For example, the QCL type applies QCL information, the QCL information including an index field of the serving cell and cell information or a reference signal of the non-serving cell.

In the embodiments of this disclosure, reference may be made to relevant steps in embodiments 1 and 2 for functions of the above units, which shall not be repeated herein any further.

It can be seen from the above embodiment that the terminal equipment uses the reference signal configured by the network device for radio link failure detection to perform radio link failure detection upon receiving configuration of a beam of a non-serving cell from the network device, or uses the reference signal of the TCI state associated with the serving cell for radio link failure detection. Hence, in inter-cell beam management, radio link failure detection of the serving cell may be performed, so as to avoid delays in RRC connection recovery and service interruptions, thereby ensuring system performances.

### Embodiment 8

The embodiments of this disclosure provide an inter-cell beam management apparatus, applicable to a terminal equipment. As a principle of the apparatus for solving problems is identical to that of the method in embodiment 4, reference may be made to the implementation of the method in embodiment 4 for implementation of the apparatus, with identical contents being not going to be repeated herein any further.

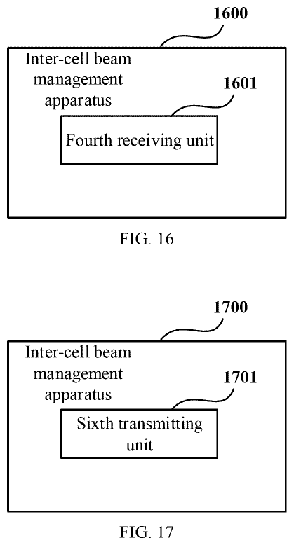

FIG. 16 is a schematic diagram of the inter-cell beam management apparatus of embodiment 8 of this disclosure. As shown in FIG. 16, an inter-cell beam management apparatus 1600 includes: a fourth receiving unit 1601 configured to receive TCI state information of a non-serving cell from a network device.

That is, the network device transmits the TCI state information of the non-serving cell to a terminal equipment.

In the embodiments of this disclosure, the TCI state information may be unified TCI state information, or TCI state information associated with PDCCH reception, or downlink TCI state information.

In the embodiments of this disclosure, the TCI state information of the non-serving cell may be associated with the reference signal information of inter-cell beam management and/or the cell information of inter-cell beam management, or the TCI state information of the non-serving cell may include reference signal information of inter-cell beam management and/or cell information of inter-cell beam management, or the TCI state information of the non-serving cell may include one or more QCL types.

For example, the QCL type applies QCL information, the QCL information including an index field of the serving cell and the cell information or reference signal of the non-serving cell.

For example, the apparatus may further include a third processing unit configured to apply the cell information or reference signal of the non-serving cell, and/or ignore the index field of the serving cell.

In the embodiments of this disclosure, reference may be made to relevant steps in embodiment 4 for functions of the above units, which shall not be repeated herein any further.

It can be seen from the above embodiment that the terminal equipment receives the TCI state information of the non-serving cell from the network device. Thus, inter-cell beam management may be achieved in a case where a terminal equipment is not provided with a reference signal for radio link monitoring and is provided with TCI states associated with reception including one or more DCHs.

### Embodiment 9

The embodiments of this disclosure provide an inter-cell beam management apparatus, applicable to a network device. As a principle of the apparatus for solving problems is identical to that of the method in embodiment 5, reference may be made to the implementation of the method in embodiment 5 for implementation of the apparatus, with identical contents being not going to be repeated herein any further.

FIG. 17 is a schematic diagram of the inter-cell beam management apparatus of embodiment 9 of this disclosure. As shown in FIG. 17, the inter-cell beam management apparatus 1700 includes:
a sixth transmitting unit 1701 configured to transmit TCI state information of a non-serving cell to a terminal equipment.

In the embodiments of this disclosure, the TCI state information may be unified TCI state information, or TCI state information associated with PDCCH reception, or downlink TCI state information.

In the embodiments of this disclosure, the TCI state information of the non-serving cell may be associated with reference signal information of inter-cell beam management and/or cell information of inter-cell beam management, or the TCI state information of the non-serving cell may include the reference signal information of inter-cell beam management and/or the cell information of inter-cell beam management, or the TCI state information of the non-serving cell may include one or more QCL types.

For example, the QCL type applies QCL information, the QCL information including an index field of the serving cell and the cell information or reference signal of the non-serving cell.

For example, the terminal equipment applies the cell information or reference signal of the non-serving cell, and/or ignores the index field of the serving cell.

In the embodiments of this disclosure, reference may be made to relevant steps in embodiments 4 and 5 for functions of the above units, which shall not be repeated herein any further.

It can be seen from the above embodiment that the terminal equipment receives the TCI state information of the non-serving cell from the network device. Thus, inter-cell beam management may be achieved in a case where a terminal equipment is not provided with a reference signal for radio link monitoring and is provided with TCI states associated with reception including one or more DCHs.

### Embodiment 10

The embodiments of this disclosure provide a terminal equipment, including the inter-cell beam management apparatus as described in embodiment 6.

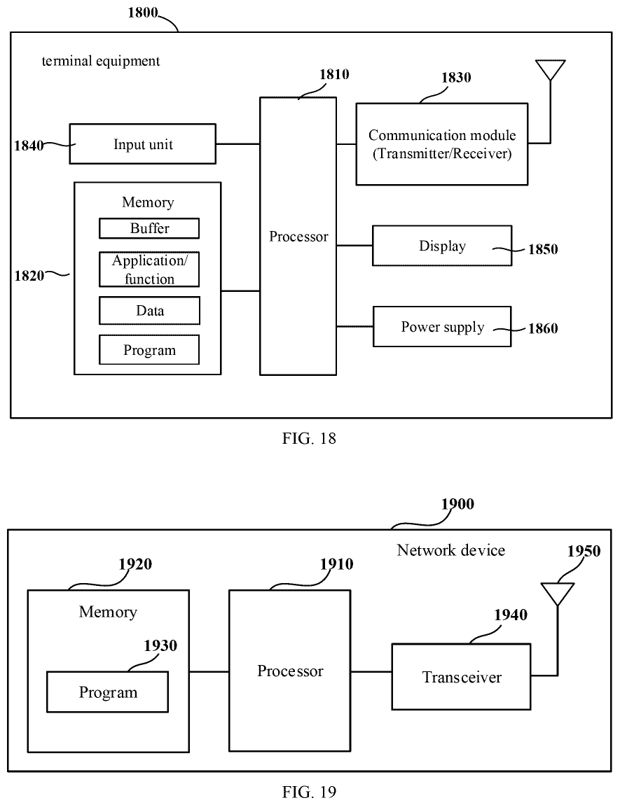

FIG. 18 is a block diagram of a systematic structure of the terminal equipment of embodiment 10 of this disclosure. As shown in FIG. 18, a terminal equipment 1800 may include a processor 1810 and a memory 1820, the memory 1820 being coupled to the processor 1810. It should be noted that this figure is illustrative only, and other types of structures may also be used, so as to supplement or replace this structure and achieve a telecommunications function or other functions.

In one implementation, functions of the inter-cell beam management apparatus may be integrated into the processor 1810. The processor 1810 may be configured to: receive configuration of a beam of a non-serving cell from a network device; and perform radio link failure detection by using a reference signal configured by the network device for radio link failure detection; or, perform radio link failure detection by using a reference signal of a TCI state with which a serving cell is associated.

In another implementation, the inter-cell beam management apparatus and the processor 1810 may be configured separately; for example, the inter-cell beam management apparatus may be configured as a chip connected to the processor 1810, and the functions of the inter-cell beam management apparatus are executed under control of the processor 1810.

As shown in FIG. 18, the terminal equipment 1800 may further include a communication module 1830, an input unit 1840, a display 1850, and a power supply 1860. It should be noted that the terminal equipment 1800 does not necessarily include all the parts shown in FIG. 18, and furthermore, the terminal equipment 1800 may include parts not shown in FIG. 18, and the related art may be referred to.

As shown in FIG. 18, the processor 1810 is sometimes referred to as a controller or an operational control, which may include a microprocessor or other processor devices and/or logic devices. The processor 1810 receives input and controls operations of components of the terminal equipment 1800.

The memory 1820 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1810 may execute programs stored in the memory 1820, so as to realize information storage or processing, etc. Functions of other parts are similar to those of the related art, which shall not be described herein any further. The parts of the terminal equipment 1800 may be realized by specific hardware, firmware, software, or any combination thereof, without departing from the scope of this disclosure.

It can be seen from the above embodiment that the terminal equipment uses the reference signal configured by the network device for radio link failure detection to perform radio link failure detection upon receiving configuration of a beam of a non-serving cell from the network device, or uses the reference signal of the TCI state associated with the serving cell for radio link failure detection. Hence, in inter-cell beam management, radio link failure detection of the serving cell may be performed, so as to avoid delays in RRC connection recovery and service interruptions, thereby ensuring system performances.

### Embodiment 11

The embodiments of this disclosure provide a network device, including the inter-cell beam management apparatus as described in embodiment 7.

FIG. 19 is a block diagram of a systematic structure of the network device of embodiment 11 of this disclosure. As shown in FIG. 19, a network device 1900 may include a processor 1910 and a memory 1920, the memory 1920 being coupled to the processor 1910. The memory 1920 may store various data, and furthermore, it may store a program 1930 for information processing, and execute the program 1930 under control of the processor 1910, so as to receive various information transmitted by a terminal equipment, and transmit various information to the terminal equipment.

In one implementation, the functions of the inter-cell beam management apparatus may be integrated into the processor 1910. The processor 1910 may be configured to: transmit configuration of a beam of a non-serving cell to a terminal equipment; and transmit a reference signal for radio link failure detection to the terminal equipment; and/or, transmit a reference signal of a TCI state with which a serving cell is associated to the terminal equipment.

In another implementation, the inter-cell beam management apparatus and the processor 1910 may be configured separately; for example, the inter-cell beam management apparatus may be configured as a chip connected to the processor 1910, and the functions of the inter-cell beam management apparatus are executed under control of the processor 1910.

Furthermore, as shown in FIG. 19, the network device 1900 may include a transceiver 1940, and an antenna 1950, etc. Wherein, functions of the above components are similar to those in the related art, and shall not be described herein any further. It should be noted that the network device 1900 does not necessarily include all the parts shown in FIG. 19, and furthermore, the network device 1900 may include parts not shown in FIG. 19, and the related art may be referred to.

It can be seen from the above embodiment that the terminal equipment uses the reference signal configured by the network device for radio link failure detection to perform radio link failure detection upon receiving configuration of a beam of a non-serving cell from the network device, or uses the reference signal of the TCI state associated with the serving cell for radio link failure detection. Hence, in inter-cell beam management, radio link failure detection of the serving cell may be performed, so as to avoid delays in RRC connection recovery and service interruptions, thereby ensuring system performances.

### Embodiment 12

The embodiments of this disclosure provide a terminal equipment, including the inter-cell beam management apparatus as described in embodiment 8.

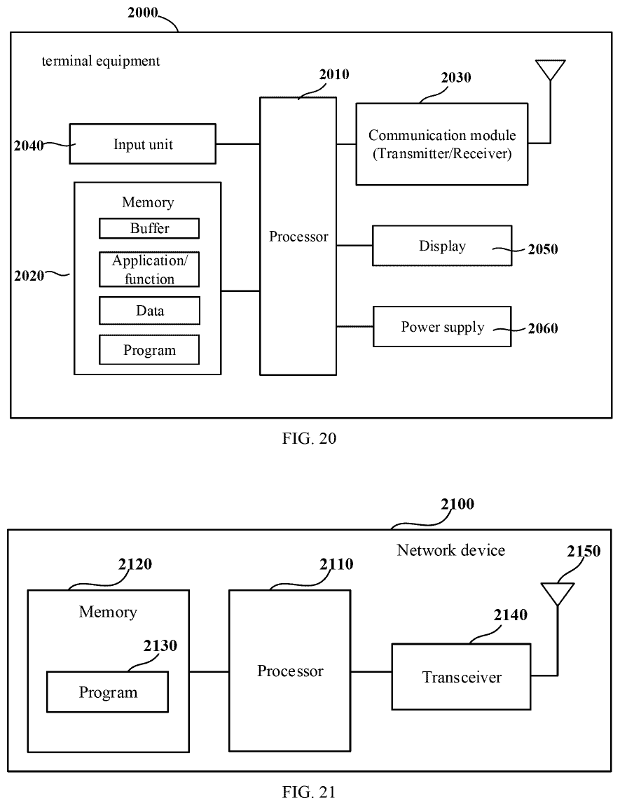

FIG. 20 is a block diagram of a systematic structure of the terminal equipment of embodiment 12 of this disclosure. As shown in FIG. 20, a terminal equipment 2000 may include a processor 2010 and a memory 2020, the memory 2020 being coupled to the processor 2010. It should be noted that this figure is illustrative only, and other types of structures may also be used, so as to supplement or replace this structure and achieve a telecommunications function or other functions.

In one implementation, functions of the inter-cell beam management apparatus may be integrated into the processor 2010. The processor 2010 may be configured to: receive TCI state information of a non-serving cell from a network device.

In another implementation, the inter-cell beam management apparatus and the processor 2010 may be configured separately; for example, the inter-cell beam management apparatus may be configured as a chip connected to the processor 2010, and the functions of the inter-cell beam management apparatus are executed under control of the processor 2010.

As shown in FIG. 20, the terminal equipment 2000 may further include a communication module 2030, an input unit 2040, a display 2050, and a power supply 2060. It should be noted that the terminal equipment 2000 does not necessarily include all the parts shown in FIG. 20, and furthermore, the terminal equipment 2000 may include parts not shown in FIG. 20, and the related art may be referred to.

As shown in FIG. 20, the processor 2010 is sometimes referred to as a controller or an operational control, which may include a microprocessor or other processor devices and/or logic devices. The processor 2010 receives input and controls operations of components of the terminal equipment 2000.

The memory 2020 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 2010 may execute programs stored in the memory 2020, so as to realize information storage or processing, etc. Functions of other parts are similar to those of the related art, which shall not be described herein any further. The parts of the terminal equipment 2000 may be realized by specific hardware, firmware, software, or any combination thereof, without departing from the scope of this disclosure.

It can be seen from the above embodiment that the terminal equipment receives the TCI state information of the non-serving cell from the network device. Thus, inter-cell beam management may be achieved in a case where a terminal equipment is not provided with a reference signal for radio link monitoring and is provided with TCI states associated with reception including one or more DCHs.

### Embodiment 13

The embodiments of this disclosure provide a network device, including the inter-cell beam management apparatus as described in embodiment 9.

FIG. 21 is a block diagram of a systematic structure of the network device of embodiment 13 of this disclosure. As shown in FIG. 21, a network device 2100 may include a processor 2110 and a memory 2120, the memory 2120 being coupled to the processor 2110. Wherein, the memory 2120 may store various data, and furthermore, it may store a program 2130 for information processing, and execute the program 2130 under control of the processor 2110, so as to receive various information transmitted by a terminal equipment, and transmit various information to the terminal equipment.

In one implementation, the functions of the inter-cell beam management apparatus may be integrated into the processor 2110. The processor 2110 may be configured to: transmit TCI state information of a non-serving cell to a terminal equipment.

In another implementation, the inter-cell beam management apparatus and the processor 2110 may be configured separately; for example, the inter-cell beam management apparatus may be configured as a chip connected to the processor 2110, and the functions of the inter-cell beam management apparatus are executed under control of the processor 2110.

Furthermore, as shown in FIG. 21, the network device 2100 may include a transceiver 2140, and an antenna 2150, etc. Wherein, functions of the above components are similar to those in the related art, and shall not be described herein any further. It should be noted that the network device 2100 does not necessarily include all the parts shown in FIG. 21, and furthermore, the network device 2100 may include parts not shown in FIG. 21, and the related art may be referred to.

It can be seen from the above embodiment that the terminal equipment receives the TCI state information of the non-serving cell from the network device. Thus, inter-cell beam management may be achieved in a case where a terminal equipment is not provided with a reference signal for radio link monitoring and is provided with TCI states associated with reception including one or more DCHs.

### Embodiment 14

The embodiments of this disclosure provide a communication system, including the terminal equipment described in embodiment 10 and/or the network device described in embodiment 11, and reference may be made to the disclosure contained in embodiments 10 and 11 for details.

For example, reference may be made to FIG. 1 for a structure of the communication system. As shown in FIG. 1, the communication system 100 includes the network device 101 and the terminal equipment 102. The terminal equipment 102 may be identical to the terminal equipment described in embodiment 10, and the network device 101 may be identical to the network device described in embodiment 11, with repeated parts being not going to be described herein any further.

### Embodiment 15

The embodiments of this disclosure provide a communication system, including the terminal equipment described in embodiment 12 and/or the network device described in embodiment 13, and reference may be made to the disclosure contained in embodiments 12 and 13 for details.

For example, reference may be made to FIG. 1 for a structure of the communication system. As shown in FIG. 1, the communication system 100 includes the network device 101 and the terminal equipment 102. The terminal equipment 102 may be identical to the terminal equipment described in embodiment 12, and the network device 101 may be identical to the network device described in embodiment 13, with repeated parts being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 12 may either correspond to software modules of procedures of a computer program, or correspond to hardware modules. Such software modules may respectively correspond to the steps shown in FIG. 4. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 12 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 12 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

### Supplement I

1. An inter-cell beam management apparatus, applicable to a terminal equipment, the apparatus including:
a first receiving unit configured to receive configuration of a beam of a non-serving cell from a network device; and
a first detecting unit configured to perform radio link failure detection by using a reference signal configured by the network device for radio link failure detection; or, a second detecting unit configured to perform radio link failure detection by using a reference signal of a TCI state with which a serving cell is associated.

2. The apparatus according to supplement 1, wherein the first receiving unit includes:
a second receiving unit configured to receive reference signal information of inter-cell beam management and/or cell information of inter-cell beam management from the network device;
and/or, a third receiving unit configured to receive TCI state information of the non-serving cell from the network device.

3. The apparatus according to supplement 2, wherein,
the reference signal information of inter-cell beam management and/or the cell information of inter-cell beam management is/are information corresponding to a cell.

4. The apparatus according to supplement 2 or 3, wherein,
the reference signal of the reference signal information of inter-cell beam management includes an SSB and/or a CSI-RS.

5. The apparatus according to any one of supplements 2-4, wherein,
the reference signal information of inter-cell beam management includes an SSB index and/or a CSI-RS identity from the non-serving cell.

6. The apparatus according to supplement 2 or 3, wherein,
the cell information includes a physical cell identity.

7. The apparatus according to supplement 2 or 3 or 6, wherein,
the cell information of the inter-cell beam management includes a physical cell identity of the non-serving cell.

8. The apparatus according to any one of supplements 2-7, wherein,
the TCI state information is unified TCI state information, or TCI state information associated with PDCCH reception, or downlink TCI state information.

9. The apparatus according to any one of supplements 2-8, wherein,
the TCI state information of the non-serving cell is associated with the reference signal information of inter-cell beam management and/or the cell information of inter-cell beam management; or,
the TCI state information of the non-serving cell includes the reference signal information of inter-cell beam management and/or the cell information of inter-cell beam management; or,
the TCI state information of the non-serving cell includes one or more QCL types.

10. The apparatus according to supplement 9, wherein,
the QCL types apply QCL information, the QCL information including a serving cell index field, and cell information or a reference signal of the non-serving cell.

11. The apparatus according to supplement 10, wherein the apparatus further includes:
a first processing unit configured to apply the cell information or reference signal of the non-serving cell, and/or ignore the serving cell index field.

12. The apparatus according to supplement 1, wherein the reference signal for radio link failure detection includes:
a reference signal used by the terminal equipment in performing radio link monitoring; and/or,
a reference signal for radio link monitoring with a purpose set to be “radio link failure” or “both” in a failure detection resource addition modification list.

13. The apparatus according to supplement 12, wherein the reference signal used by the terminal equipment in performing radio link monitoring includes at least one of the following:
an SSB configured for an initial downlink BWP of a special cell;
an SSB configured for a downlink BWP of the special cell including an SSB with which the initial downlink BWP is associated; and
a CSI-RS configured for a downlink BWP of the special cell.

14. The apparatus according to supplement 1, wherein,
the reference signal of the TCI state with which the serving cell is associated is a reference signal of an active TCI state with which the serving cell is associated.

15. The apparatus according to supplement 1 or 14, wherein,
the TCI state information is unified TCI state information, or TCI state information associated with PDCCH reception, or downlink TCI state information.

16. The apparatus according to supplement 1 or 14 or 15, wherein,
the TCI state with which the serving cell is associated includes a reference signal of a serving cell and/or cell information of a serving cell, or
the TCI state with which the serving cell is associated is associated with a reference signal of a serving cell.

17. The apparatus according to supplement 16, wherein,
that the TCI state associated with the serving cell is associated with a reference signal of a serving cell includes:
that the TCI state associated with the serving cell includes one or more QCL types.

18. The apparatus according to supplement 17, wherein,
the QCL types apply QCL information, the QCL information including a serving cell index field, and cell information or a reference signal of the non-serving cell.

19. The apparatus according to supplement 18, wherein the apparatus further includes:
a second processing unit configured to apply the cell information or reference signal of the non-serving cell, and/or ignore the serving cell index field.

20. The apparatus according to any one of supplements 1 and 14-19, wherein,
the second detecting unit performs radio link failure detection by using the reference signal of the TCI state with which the serving cell is associated, until the terminal equipment communicates with a network by using a beam of the non-serving cell with which the serving cell is associated.

21. The apparatus according to supplement 20, wherein the beam of the non-serving cell is associated with a serving cell.

22. The apparatus according to supplement 21, wherein that the beam of the non-serving cell is associated with a serving cell includes:
that the beam of the non-serving cell is included in configuration of a serving cell, or
the beam of the non-serving cell includes cell information of a serving cell.

23. The apparatus according to any one of supplements 20-22, wherein that the terminal equipment communicates with a network by using a beam of the non-serving cell with which the serving cell is associated includes:
the network device, via L1 information and/or an MAC CE, activates the TCI state with which the beam is associated.

24. The apparatus according to any one of supplements 1-23, wherein,
the non-serving cell is associated with the serving cell.

25. The apparatus according to any one of supplements 1-24, wherein,
when the terminal equipment is configured with carrier aggregation, the serving cell includes a special cell and/or a primary cell;
when the terminal equipment is configured with dual connectivity, the serving cell includes at least one of a special cell, a primary cell of a primary cell group and a primary secondary cell of a secondary cell group;
and when the terminal equipment is configured with carrier aggregation and dual connectivity, the serving cell includes at least one of a special cell, a primary cell of a primary cell group, and a primary secondary cell of a secondary cell group.

26. An inter-cell beam management apparatus, applicable to a network device, the apparatus including:
a first transmitting unit configured to transmit configuration of a beam of a non-serving cell to a terminal equipment; and
a second transmitting unit configured to transmit a reference signal for radio link failure detection to the terminal equipment; and/or, a third transmitting unit configured to transmit a reference signal of a TCI state with which a serving cell is associated to the terminal equipment.

27. The apparatus according to supplement 26, wherein the first transmitting unit includes:
a fourth transmitting unit configured to transmit reference signal information of inter-cell beam management and/or cell information of inter-cell beam management to the terminal equipment; and/or,
a fifth transmitting unit configured to transmit TCI state information of the non-serving cell to the terminal equipment.

28. The apparatus according to supplement 27, wherein,
the reference signal information of inter-cell beam management and/or the cell information of inter-cell beam management is/are information corresponding to a cell.

29. The apparatus according to supplement 27 or 28, wherein,
the reference signal of the reference signal information of inter-cell beam management includes an SSB and/or a CSI-RS.

30. The apparatus according to any one of supplements 27-29, wherein,
the reference signal information of inter-cell beam management includes an SSB index and/or a CSI-RS identity from the non-serving cell.

31. The apparatus according to supplement 27 or 28, wherein,
the cell information includes a physical cell identity.

32. The apparatus according to supplement 27 or 28 or 31, wherein,
the cell information of the inter-cell beam management includes a physical cell identity of the non-serving cell.

33. The apparatus according to any one of supplements 27-32, wherein,
the TCI state information is unified TCI state information, or TCI state information associated with PDCCH reception, or downlink TCI state information.

34. The apparatus according to any one of supplements 27-33, wherein,
the TCI state information of the non-serving cell is associated with the reference signal information of inter-cell beam management and/or the cell information of inter-cell beam management; or,
the TCI state information of the non-serving cell includes the reference signal information of inter-cell beam management and/or the cell information of inter-cell beam management; or,
the TCI state information of the non-serving cell includes one or more QCL types.

35. The apparatus according to supplement 34, wherein,
the QCL types apply QCL information, the QCL information including a serving cell index field, and cell information or a reference signal of the non-serving cell.

36. The apparatus according to supplement 26, wherein the reference signal for radio link failure detection includes:
a reference signal used by terminal equipment in performing radio link monitoring; and/or
a radio link monitoring reference signal with a target set to be “radio link failed” or “both” in a failure detection resource addition and modification list.

37. The apparatus according to supplement 36, wherein the reference signal used by the terminal equipment in performing radio link monitoring includes at least one of the following:
an SSB configured for an initial downlink BWP of a special cell;
an SSB configured for a downlink BWP of the special cell including an SSB with which the initial downlink BWP is associated; and
a CSI-RS configured for a downlink BWP of the special cell.

38. The apparatus according to supplement 26, wherein,
the reference signal of the TCI state with which the serving cell is associated is a reference signal of an active TCI state with which the serving cell is associated.

39. The apparatus according to supplement 26 or 38, wherein,
the TCI state information is unified TCI state information, or TCI state information associated with PDCCH reception, or downlink TCI state information.

40. The apparatus according to supplement 26 or 38 or 39, wherein,
the TCI state with which the serving cell is associated includes a reference signal of a serving cell and/or cell information of a serving cell, or
the TCI state with which the serving cell is associated is associated with a reference signal of a serving cell.

41. The apparatus according to supplement 40, wherein,
that the TCI state associated with the serving cell is associated with a reference signal of a serving cell includes:
that the TCI state associated with the serving cell includes one or more QCL types.

42. The apparatus according to supplement 41, wherein,
the QCL types apply QCL information, the QCL information including a serving cell index field, and cell information or a reference signal of the non-serving cell.

43. An inter-cell beam management apparatus, applicable to a terminal equipment, the apparatus including:
a fourth receiving unit configured to receive TCI state information of a non-serving cell from a network device.

44. The apparatus according to supplement 43, wherein,
the TCI state information is unified TCI state information, or TCI state information associated with PDCCH reception, or downlink TCI state information.

45. The apparatus according to supplement 43 or 44, wherein,
the TCI state information of the non-serving cell is associated with the reference signal information of inter-cell beam management and/or the cell information of inter-cell beam management; or,
the TCI state information of the non-serving cell includes the reference signal information of inter-cell beam management and/or the cell information of inter-cell beam management; or,
the TCI state information of the non-serving cell includes one or more QCL types.

46. The apparatus according to supplement 45, wherein,
the QCL types apply QCL information, the QCL information including a serving cell index field, and cell information or a reference signal of the non-serving cell.

47. The apparatus according to supplement 46, wherein the apparatus further includes:
a third processing unit configured to apply the cell information or reference signal of the non-serving cell, and/or ignore the serving cell index field.

48. An inter-cell beam management apparatus, applicable to a network device, the apparatus including:
a sixth transmitting unit configured to transmit TCI state information of a non-serving cell to a terminal equipment.

49. The apparatus according to supplement 48, wherein,
the TCI state information is unified TCI state information, or TCI state information associated with PDCCH reception, or downlink TCI state information.

50. The apparatus according to supplement 48 or 49, wherein,
the TCI state information of the non-serving cell is associated with the reference signal information of inter-cell beam management and/or the cell information of inter-cell beam management; or,
the TCI state information of the non-serving cell includes the reference signal information of inter-cell beam management and/or the cell information of inter-cell beam management; or,
the TCI state information of the non-serving cell includes one or more QCL types.

51. The apparatus according to supplement 50, wherein,
the QCL types apply QCL information, the QCL information including a serving cell index field, and cell information or a reference signal of the non-serving cell.

52. The apparatus according to supplement 51, wherein,
the terminal equipment applies the cell information or reference signal of the non-serving cell, and/or ignores the serving cell index field.

53. A terminal equipment, including the apparatus as described in any one of supplements 1-25.

54. A network device, including the apparatus as described in any one of supplements 26-42.

55. A terminal equipment, including the apparatus as described in any one of supplements 43-46.

56. A network device, including the apparatus as described in any one of supplements 47-51.

57. A communication system, including the terminal equipment as described in supplement 53 and/or the network device as described in supplement 54.

58. A communication system, including the terminal equipment as described in supplement 55 and/or the network device as described in supplement 56.

### Supplement II

1. An inter-cell beam management method, applicable to a terminal equipment, the method including:
receiving configuration of a beam of a non-serving cell from a network device; and
performing radio link failure detection by using a reference signal configured by the network device for radio link failure detection; or, performing radio link failure detection by using a reference signal of a TCI state with which a serving cell is associated.

2. The method according to supplement 1, wherein the receiving configuration of a beam of a non-serving cell from a network device includes:
receiving reference signal information of inter-cell beam management and/or cell information of inter-cell beam management from the network device; and/or,
receiving TCI state information of the non-serving cell from the network device.

3. The method according to supplement 2, wherein,
the reference signal information of inter-cell beam management and/or the cell information of inter-cell beam management is/are information corresponding to a cell.

4. The method according to supplement 2 or 3, wherein,
the reference signal of the reference signal information of inter-cell beam management includes an SSB and/or a CSI-RS.

5. The method according to any one of supplements 2-4, wherein,
the reference signal information of inter-cell beam management includes an SSB index and/or a CSI-RS identity from the non-serving cell.

6. The method according to supplement 2 or 3, wherein,
the cell information includes a physical cell identity.

7. The method according to supplement 2 or 3 or 6, wherein,
the cell information of the inter-cell beam management includes a physical cell identity of the non-serving cell.

8. The method according to any one of supplements 2-7, wherein,
the TCI state information is unified TCI state information, or TCI state information associated with PDCCH reception, or downlink TCI state information.

9. The method according to any one of supplements 2-8, wherein,
the TCI state information of the non-serving cell is associated with the reference signal information of inter-cell beam management and/or the cell information of inter-cell beam management; or,
the TCI state information of the non-serving cell includes the reference signal information of inter-cell beam management and/or the cell information of inter-cell beam management; or,
the TCI state information of the non-serving cell includes one or more QCL types.

10. The method according to supplement 9, wherein,
the QCL types apply QCL information, the QCL information including a serving cell index field, and cell information or a reference signal of the non-serving cell.

11. The method according to supplement 10, wherein the method further includes:
applying the cell information or reference signal of the non-serving cell, and/or ignoring the serving cell index field, by the terminal equipment.

12. The method according to supplement 1, wherein the reference signal for radio link failure detection includes:
a reference signal used by the terminal equipment in performing radio link monitoring; and/or,
a reference signal for radio link monitoring with a purpose set to be “radio link failure” or “both” in a failure detection resource addition modification list.

13. The method according to supplement 12, wherein the reference signal used by the terminal equipment in performing radio link monitoring includes at least one of the following:
an SSB configured for an initial downlink BWP of a special cell;
an SSB configured for a downlink BWP of the special cell including an SSB with which the initial downlink BWP is associated; and
a CSI-RS configured for a downlink BWP of the special cell.

14. The method according to supplement 1, wherein,
the reference signal of the TCI state with which the serving cell is associated is a reference signal of an active TCI state with which the serving cell is associated.

15. The method according to supplement 1 or 14, wherein,
the TCI state information is unified TCI state information, or TCI state information associated with PDCCH reception, or downlink TCI state information.

16. The method according to supplement 1 or 14 or 15, wherein,
the TCI state with which the serving cell is associated includes a reference signal of a serving cell and/or cell information of a serving cell, or
the TCI state with which the serving cell is associated is associated with a reference signal of a serving cell.

17. The method according to supplement 16, wherein,
that the TCI state associated with the serving cell is associated with a reference signal of a serving cell includes:
that the TCI state associated with the serving cell includes one or more QCL types.

18. The method according to supplement 17, wherein,
the QCL types apply QCL information, the QCL information including a serving cell index field, and cell information or a reference signal of the non-serving cell.

19. The method according to supplement 18, wherein the method further includes:
applying the cell information or reference signal of the non-serving cell, and/or ignoring the serving cell index field, by the terminal equipment.

20. The method according to any one of supplements 1 and 14-19, wherein the performing radio link failure detection by using a reference signal of a TCI state with which a serving cell is associated includes:
performing radio link failure detection by using the reference signal of the TCI state with which the serving cell is associated, until the terminal equipment communicates with a network by using a beam of the non-serving cell with which the serving cell is associated.

21. The method according to supplement 20, wherein the beam of the non-serving cell is associated with a serving cell.

22. The method according to supplement 21, wherein that the beam of the non-serving cell is associated with a serving cell includes:
that the beam of the non-serving cell is included in configuration of a serving cell, or
the beam of the non-serving cell includes cell information of a serving cell.

23. The method according to any one of supplements 20-22, wherein that the terminal equipment communicates with a network by using a beam of the non-serving cell with which the serving cell is associated includes:

the network device, via L1 information and/or an MAC CE, activates the TCI state with which the beam is associated.

24. The method according to any one of supplements 1-23, wherein,
the non-serving cell is associated with the serving cell.

25. The method according to any one of supplements 1-24, wherein,
when the terminal equipment is configured with carrier aggregation, the serving cell includes a special cell and/or a primary cell;
when the terminal equipment is configured with dual connectivity, the serving cell includes at least one of a special cell, a primary cell of a primary cell group and a primary secondary cell of a secondary cell group;
and when the terminal equipment is configured with carrier aggregation and dual connectivity, the serving cell includes at least one of a special cell, a primary cell of a primary cell group, and a primary secondary cell of a secondary cell group.

26. An inter-cell beam management method, applicable to a network device, the method including:
transmitting configuration of a beam of a non-serving cell to a terminal equipment; and
transmitting a reference signal for radio link failure detection to the terminal equipment; and/or, transmitting a reference signal of a TCI state with which a serving cell is associated to the terminal equipment.

27. The method according to supplement 26, wherein the transmitting configuration of a beam of a non-serving cell to a terminal equipment includes:
transmitting reference signal information of inter-cell beam management and/or cell information of inter-cell beam management to the terminal equipment; and/or,
transmitting TCI state information of the non-serving cell to the terminal equipment.

28. The method according to supplement 27, wherein,
the reference signal information of inter-cell beam management and/or the cell information of inter-cell beam management is/are information corresponding to a cell.

29. The method according to supplement 27 or 28, wherein,
the reference signal of the reference signal information of inter-cell beam management includes an SSB and/or a CSI-RS.

30. The method according to any one of supplements 27-29, wherein,
the reference signal information of inter-cell beam management includes an SSB index and/or a CSI-RS identity from the non-serving cell.

31. The method according to supplement 27 or 28, wherein,
the cell information includes a physical cell identity.

32. The method according to supplement 27 or 28 or 31, wherein,
the cell information of the inter-cell beam management includes a physical cell identity of the non-serving cell.

33. The method according to any one of supplements 27-32, wherein,
the TCI state information is unified TCI state information, or TCI state information associated with PDCCH reception, or downlink TCI state information.

34. The method according to any one of supplements 27-33, wherein,
the TCI state information of the non-serving cell is associated with the reference signal information of inter-cell beam management and/or the cell information of inter-cell beam management; or,
the TCI state information of the non-serving cell includes the reference signal information of inter-cell beam management and/or the cell information of inter-cell beam management; or,
the TCI state information of the non-serving cell includes one or more QCL types.

35. The method according to supplement 34, wherein,
the QCL types apply QCL information, the QCL information including a serving cell index field, and cell information or a reference signal of the non-serving cell.

36. The method according to supplement 26, wherein the reference signal for radio link failure detection includes:
a reference signal used by terminal equipment in performing radio link monitoring; and/or
a radio link monitoring reference signal with a target set to be “radio link failed” or “both” in a failure detection resource addition and modification list.

37. The method according to supplement 36, wherein the reference signal used by the terminal equipment in performing radio link monitoring includes at least one of the following:
an SSB configured for an initial downlink BWP of a special cell;
an SSB configured for a downlink BWP of the special cell including an SSB with which the initial downlink BWP is associated; and
a CSI-RS configured for a downlink BWP of the special cell.

38. The method according to supplement 26, wherein,
the reference signal of the TCI state with which the serving cell is associated is a reference signal of an active TCI state with which the serving cell is associated.

39. The method according to supplement 26 or 38, wherein,
the TCI state information is unified TCI state information, or TCI state information associated with PDCCH reception, or downlink TCI state information.

40. The method according to supplement 26 or 38 or 39, wherein,
the TCI state with which the serving cell is associated includes a reference signal of a serving cell and/or cell information of a serving cell, or
the TCI state with which the serving cell is associated is associated with a reference signal of a serving cell.

41. The method according to supplement 40, wherein,
that the TCI state associated with the serving cell is associated with a reference signal of a serving cell includes:
that the TCI state associated with the serving cell includes one or more QCL types.

42. The method according to supplement 41, wherein,
the QCL types apply QCL information, the QCL information including a serving cell index field, and cell information or a reference signal of the non-serving cell.

43. An inter-cell beam management method, applicable to a terminal equipment, the method including:
receiving TCI state information of a non-serving cell from a network device.

44. The method according to supplement 43, wherein,
the TCI state information is unified TCI state information, or TCI state information associated with PDCCH reception, or downlink TCI state information.

45. The method according to supplement 43 or 44, wherein,
the TCI state information of the non-serving cell is associated with the reference signal information of inter-cell beam management and/or the cell information of inter-cell beam management; or,
the TCI state information of the non-serving cell includes the reference signal information of inter-cell beam management and/or the cell information of inter-cell beam management; or,
the TCI state information of the non-serving cell includes one or more QCL types.

46. The method according to supplement 45, wherein,
the QCL types apply QCL information, the QCL information including a serving cell index field, and cell information or a reference signal of the non-serving cell.

47. The method according to supplement 46, wherein the method further includes:
applying the cell information or reference signal of the non-serving cell, and/or ignoring the serving cell index field, by the terminal equipment.

48. An inter-cell beam management method, applicable to a network device, the method including:
transmitting TCI state information of a non-serving cell to a terminal equipment.

49. The method according to supplement 48, wherein,
the TCI state information is unified TCI state information, or TCI state information associated with PDCCH reception, or downlink TCI state information.

50. The method according to supplement 48 or 49, wherein,
the TCI state information of the non-serving cell is associated with the reference signal information of inter-cell beam management and/or the cell information of inter-cell beam management; or,
the TCI state information of the non-serving cell includes the reference signal information of inter-cell beam management and/or the cell information of inter-cell beam management; or,
the TCI state information of the non-serving cell includes one or more QCL types.

51. The method according to supplement 50, wherein,
the QCL types apply QCL information, the QCL information including a serving cell index field, and cell information or a reference signal of the non-serving cell.

52. The method according to supplement 51, wherein,
the terminal equipment applies the cell information or reference signal of the non-serving cell, and/or ignores the serving cell index field.

1. An inter-cell beam management apparatus, applicable to a network device, the apparatus comprising:
a transmitter configured to:
transmit configuration information of a beam of a non-serving cell to a terminal equipment; and
transmit a reference signal of a TCI state with which a serving cell is associated to the terminal equipment.

2. The apparatus according to claim 1, wherein,
The transmitter is further configured to:
transmit reference signal information of inter-cell beam management and/or cell information of inter-cell beam management to the terminal equipment; and/or,
transmit TCI state information of the non-serving cell to the terminal equipment.

3. The apparatus according to claim 2, wherein,
the reference signal information of inter-cell beam management comprises an SSB index and/or a CSI-RS identity from the non-serving cell.

4. The apparatus according to claim 2, wherein,
the cell information of the inter-cell beam management comprises a physical cell identity of the non-serving cell.

5. The apparatus according to claim 2, wherein,
the TCI state information of the non-serving cell is associated with the reference signal information of inter-cell beam management and/or the cell information of inter-cell beam management.

6. The apparatus according to claim 2, wherein,
the TCI state information of the non-serving cell comprises the reference signal information of inter-cell beam management and/or the cell information of inter-cell beam management; or,
the TCI state information of the non-serving cell comprises one or more QCL types.

7. The apparatus according to claim 5, wherein,
the QCL types apply QCL information, the QCL information comprising a serving cell index field, and cell information or a reference signal of the non-serving cell.

8. The apparatus according to claim 1, wherein,
the reference signal of the TCI state with which the serving cell is associated is a reference signal of an active TCI state with which the serving cell is associated.

9. An inter-cell beam management apparatus, applicable to a terminal equipment, the apparatus comprising:
a receiver configured to receive configuration information of a beam of a non-serving cell from a network device; and
processor circuitry configured to perform a measurement by using a reference signal of a TCI state with which a serving cell is associated.

10. The apparatus according to claim 9, wherein
the receiver is further configured to:
receive reference signal information of inter-cell beam management and/or cell information of inter-cell beam management from the network device; and/or,
receive TCI state information of the non-serving cell from the network device.

11. The apparatus according to claim 10, wherein,
the reference signal information of inter-cell beam management comprises an SSB index and/or a CSI-RS identifier from the non-serving cell.

12. The apparatus according to claim 10, wherein,
the cell information of the inter-cell beam management comprises a physical cell identifier of the non-serving cell.

13. The apparatus according to claim 10, wherein,
the TCI state information of the non-serving cell is associated with the reference signal information of inter-cell beam management and/or the cell information of inter-cell beam management; or,
the TCI state information of the non-serving cell comprises the reference signal information of inter-cell beam management and/or the cell information of inter-cell beam management; or,
the TCI state information of the non-serving cell comprises one or more QCL types.

14. The apparatus according to claim 13, wherein,
the QCL types apply QCL information, the QCL information comprising a serving cell index field, and cell information or a reference signal of the non-serving cell.

15. The apparatus according to claim 14, wherein
the processor circuitry is configured to apply the cell information or reference signal of the non-serving cell, and/or ignore the serving cell index field.

16. The apparatus according to claim 9, wherein,
the reference signal of the TCI state with which the serving cell is associated is a reference signal of an active TCI state with which the serving cell is associated.

17. The apparatus according to claim 9, wherein,
the non-serving cell is associated with the serving cell.
